(19) United States
(12) Patent Application Publication
(10) Pub. No.: US 2023/0170731 A1
(43) Pub. Date: Jun. 1, 2023

(54) ENERGY STORAGE SYSTEM FOR A LOAD HANDLING DEVICE

(71) Applicant: Ocado Innovation Limited, Hatfield, Hertfordshire (GB)

(72) Inventors: Philip CORSER, Hatfield, Hertfordshire (GB); David BROWN, Hatfield, Hertfordshire (GB); Javier NADAL, Hatfield, Hertfordshire (GB); Giovanni PASSETTI, Hatfield, Hertfordshire (GB)

(73) Assignee: Ocado Innovation Limited, Hatfield, Hertfordshire (GB)

(21) Appl. No.: 17/920,925

(22) PCT Filed: Apr. 22, 2021
(86) PCT No.: PCT/EP2021/060551

§ 371 Date: Oct. 24, 2022

(30) Foreign Application Priority Data
Apr. 24, 2020 (GB) 2006089.3
Jul. 10, 2020 (GB) 2010704.1
Dec. 23, 2020 (GB) 2020583.7

(51) Int. Cl. H02J 7/34; H02J 7/00; H02J 50/10

(52) U.S. Cl. CPC H02J 7/345; H02J 7/007182; H02J 7/0014; H02J 50/10; H02J 2207/50; H02J 2207/20

(57) ABSTRACT

A load handling device is disclosed for lifting and moving one or more containers stacked in a storage system having a grid framework supporting a pathway arranged in a grid pattern above the stacks of containers, the load handling device including a vehicle body housing a driving; a lifting device having a lifting drive assembly and a grabber device, wherein the lifting drive assembly and/or the driving mechanism includes at least one motor forming electrical loads; a rechargeable power source; and an assembly of one or more supercapacitor modules; wherein the electrical loads are connected across the supercapacitor modules, and the rechargeable power source is connected in parallel to the supercapacitor modules to provide power to re supercapacitor modules.

### TECHNICAL FIELD

The present invention relates to the field of load handling devices for handling storage containers or bins in a store comprising a grid of stacked containers, more specifically of an energy storage system of a load handling device.

### BACKGROUND

Storage systems comprising a three-dimensional storage grid structure, within which storage containers/bins are stacked on top of each other, are well known. PCT Publication No. WO2015/185628A (Ocado) describes a known storage and fulfilment system in which stacks 10 of bins or containers are arranged within a grid framework structure. The bins or containers are accessed by load handling devices operative on tracks located on the top of the grid framework structure. A system of this type is illustrated schematically in FIGS. 1 to 3 of the accompanying drawings. As shown in FIGS. 1 and 2, stackable containers, known as bins 10, are stacked on top of one another to form stacks 12. The stacks 12 are arranged in a grid framework structure 14 in a warehousing or manufacturing environment. The grid framework is made up of a plurality of storage columns or grid columns. Each grid in the grid framework structure has at least one grid column for storage of a stack of containers. FIG. 1 is a schematic perspective view of the grid framework structure 14, and FIG. 2 is a top-down view showing a stack 12 of bins 10 arranged within the framework structure 14. Each bin 10 typically holds a plurality of product items (not shown), and the product items within a bin 10 may be identical, or may be of different product types depending on the application. The grid framework structure 14 comprises a plurality of upright members 16 that support horizontal members 18, 20. A first set of parallel horizontal members 18 is arranged 25 perpendicularly to a second set of parallel horizontal members 20 to form a plurality of horizontal grid structures comprising a plurality of grid cells 23 supported by the upright members 16. The members 16, 18, 20 are typically manufactured from metal. The bins 10 are stacked within the grid cells 23 between the members 16, 18, 20 of the grid framework structure 14, so that the grid framework structure 14 guards against horizontal movement of the stacks 12 of bins 10, and guides vertical movement of the bins 10.

The top level of the grid framework structure 14 includes rails 22 arranged in a grid pattern comprising a plurality of grid cells 23 across the top of the stacks 12. Referring additionally to FIG. 3, the rails 22 support a plurality of load handling devices 30. A first set 22a of parallel rails 22 guide movement of the robotic load handling devices 30 in a first direction (for example, an X-direction) across the top of the grid framework structure 14, and a second set 22b of parallel rails 22, arranged perpendicular to the first set 22a, guide movement of the load handling devices 30 in a second direction (for example, a Y-direction), perpendicular to the first direction. In this way, the rails 22 allow movement of the robotic load handling devices 30 laterally in two dimensions in the horizontal X-Y plane, so that a load handling device 30 can be moved into position above any of the stacks 12. A known load handling device 30 shown in FIGS. 4 and 5 comprises a vehicle body 32 is described in PCT Patent Publication No. WO2015/019055 (Ocado), hereby incorporated by reference, where each load handling device 30 only covers one grid space or grid cell 23 of the grid framework structure 14. Here, the load handling device 30 comprises a wheel assembly comprising a first set of wheels 34 consisting a pair of wheels on the front of the vehicle body 32 and a pair of wheels 34 on the back of the vehicle 32 for engaging with the first set of rails or tracks to guide movement of the device in a first direction and a second set of wheels 36 consisting of a pair of wheels 36 on each side of the vehicle 32 for engaging with the second set of rails or tracks to guide movement of the device in a second direction. Each of the sets of wheels are driven by one or more motors to enable movement of the vehicle in the X and Y directions respectively along the rails. One or both sets of wheels can be moved vertically to lift each set of wheels clear of the respective rails, thereby allowing the vehicle to move in the desired direction.

Although FIGS. 4 and 5 illustrate a load handling device occupying a single grid space where the container receiving space is a recess inside the vehicle body, the invention also encompasses a load handling device including a cantilever as part of the vehicle body, where the container receiving space is located below the cantilever arm.

The load handling device 30 is equipped with a lifting device or crane mechanism driven by one or more motors to lift a storage container which can weigh up to 30 kg from above. The crane mechanism comprises a winch tether or cable 38 wound on a spool or reel (not shown) and a grabber device 39. The lifting device comprise a set of lifting tethers 38 extending in a vertical direction and connected nearby or at the four corners of a lifting frame 39, otherwise known as a grabber device (one tether near each of the four corners of the grabber device) for releasable connection to a storage container 10. The grabber device 39 is configured to releasably grip the top of a storage container 10 to lift it from a stack of containers in a storage system of the type shown in FIGS. 1 and 2.

The wheels 34, 36 are arranged around the periphery of a cavity or recess, known as a container-receiving recess 40, in the lower part. The recess is sized to accommodate the container 10 when it is lifted by the crane mechanism, as shown in FIGS. 5a and 5b. When in the recess, the container is lifted clear of the rails beneath, so that the vehicle can move laterally to a different location. On reaching the target location, for example another stack, an access point in the storage system or a conveyor belt, the bin or container can be lowered from the container receiving portion and released from the grabber device.

Although not shown in FIGS. 1-3, the load handling device 30 is powered during operation by an on-board rechargeable power source. One common kind of rechargeable power source is a battery. Examples of rechargeable batteries are Lithium-Ion battery, Nickel-Cadmium battery, Nickel-Metal Hydride battery, Lithium-Ion Polymer battery, Thin Film battery and Smart battery Carbon Foam-based Lead Acid battery.

Batteries have the technical advantage of a high energy density, i.e. a high capacity of storing energy per unit mass, making them suitable for use in mobile applications such as load handling devices, since they store enough energy to power the device for a long time between charges. They have a lower self-discharge rate, so can retain enough charge to continue operating after a period of downtime. However, batteries have low power density so are not suited to handle high acceleration demands, and are limited in how much regeneration energy they can capture from deceleration events. Also, resistive power losses in the battery mean that excessive battery cycling converts some electrical energy into heat, which as well as wasting energy can be a problem in low temperature environments.

Other disadvantages of batteries are that they are heavy, expensive, suffer from resistive power losses, take a long time to charge, have a limited lifetime of charge/discharge cycles, and degrade over time with use. The slow charging speed means that operational time is lost while the batteries are charging. The limited number of charge/discharge cycles means that batteries have a short lifetime and need replacing frequently.

An alternative to battery technology is a supercapacitor. Supercapacitors have a high power density, making them suitable for applications with high acceleration demands (high power draw for short time) and can also capture regeneration energy from deceleration events (high power input for short time). The advantages of supercapacitors over batteries is that they are lighter, cheaper, more efficient, faster to charge, and can undergo more charge/discharge cycles with less degradation over time. Fast charging means less downtime. The main disadvantages of supercapacitors compared to batteries are that they have a high self-discharge rate (so after a period of inactivity may not retain enough charge to continue operating), and have a lower energy density.

FIG. 6 is a Ragone plot, which plots power density against energy density and shows the relative positions of different types of energy storage devices. It can be seen from the plot that supercapacitors (labelled on FIG. 6 as EDLC, electric double layer capacitors) have a low energy density but high power density, whereas lithium-ion batteries have a relatively higher energy density and lower power density.

Table 1 compares some of the properties of batteries and supercapacitors.

TABLE 1
Comparison of properties of batteries and supercapacitors

| Property | Batteries | Supercapacitors |
|---|---|---|
| Energy density | High | Low |
| Power density | Low | High |
| Cost | High | Low |
| Weight | High | Low |
| Charge/discharge cycles | Fewer | More |
| Charging speed | Slow | Fast |
| Self-discharge rate | Low | High |
| Degradation over time | Fast | Slow |
| Low-temperature | Poor | Good |
| performance | | |

Prior art load handling devices (for example, as described in PCT Patent Publication No. WO2015/019055), while having the advantage of high energy density, suffer from all of the issues with rechargeable batteries as described above.

WO2020169474A1 (AutoStore) discloses a container-handling vehicle powered by first and second rechargeable power sources, in particular a rechargeable battery and a supercapacitor. These have some of the advantages of supercapacitors, but still suffer from the disadvantages of battery degradation and energy wasted as heat.

GB2006089.3 discloses load handling devices where the primary power source is a supercapacitor, with a DCDC converter used to change the voltage. These have the advantages of a supercapacitor as discussed above, but since the supercapacitor is the only power source the load handling devices have the disadvantages that the energy density is poor and the self-discharging rate is high.

This application claims priority from UK Patent Application Nos. GB2006089.3 filed 24 Apr. 2020, GB2010704.1 filed 10 Jul. 2020, and GB2020583.7 filed 23 Dec. 2020, the content of these applications hereby being incorporated by reference.

### SUMMARY OF INVENTION

The invention is a load handling device for lifting and moving one or more containers stacked in a storage system comprising a grid framework supporting a pathway arranged in a grid pattern above the stacks of containers, the load handling device comprising:

i) a vehicle body housing a driving mechanism operatively arranged for moving the load handling device on the grid framework;
ii) a lifting device comprising a lifting drive assembly and a grabber device configured, in use, to releasably grip a container and lift the container from the stack into a container-receiving space; wherein the lifting drive assembly and/or the driving mechanism comprises at least one motor forming electrical loads;
iii) a rechargeable power source;
iv) an assembly of one or more supercapacitor modules;
characterised in that the electrical loads are connected across the assembly of one or more supercapacitor modules, and that the rechargeable power source is connected in parallel to the assembly of one or more supercapacitor modules such that the rechargeable power source is configured to provide power to the assembly of one or more supercapacitor modules.

For ease of reference, the terms “assembly of one or more supercapacitor modules” and “supercapacitor” will be used interchangeably in describing the invention. When referring to a supercapacitor, it will be understood that this term encompasses an assembly of supercapacitor modules connected in series and/or in parallel.

A common problem with load handing devices, particularly load handling devices where the rechargeable power source is a rechargeable battery, is that the battery experiences frequent charge-discharge cycles from the electrical load as a result of acceleration and operation of the lifting drive assembly and/or the driving mechanism. This puts the rechargeable battery under a lot of strain since the internal resistance of the battery causes the battery to heat up during the charge-discharge cycles. The charge-discharge cycles can cause premature aging of the battery, requiring batteries to be replaced more frequently.

To overcome this problem, the rechargeable power source in the present invention is used primarily to supply charge to one or more supercapacitor modules, rather than providing power directly to the electrical load. In comparison to a rechargeable battery, supercapacitors are more resilient to the charge-discharge cycles from the electrical load, and therefore able to withstand the surges of power draw during acceleration of the load handling device on the grid. The combination of a rechargeable battery and one or more supercapacitor modules provides a hybrid system with high power density and high energy density, combining the advantages of batteries and supercapacitors. The rechargeable power source can supply power to the assembly of one or more supercapacitor modules at a steady current, and thus avoid the damaging effects of frequent charge-discharge cycles.

The advantage of the current invention over prior art load handling devices is that the life of the rechargeable power source can be extended, thus reducing operational costs and downtime.

The load handling device may further comprise a load DCDC converter between the assembly of one or more supercapacitor modules and the electrical loads. The load DCDC converter between the assembly of one or more supercapacitor modules and the electrical loads may be a boost converter.

The load handling device may further comprise a source DCDC converter between the rechargeable power source and the assembly of one or more supercapacitor modules. The source DCDC converter between the rechargeable power source and the assembly of one or more supercapacitor modules may be a buck converter.

A controller may be configured to vary the power supplied from the rechargeable power source to the assembly of one or more supercapacitor modules. The controller may be configured to instruct the rechargeable power source to supply charge to the assembly of one or more supercapacitor modules when the voltage of the assembly of one or more supercapacitor modules is below a predetermined supercapacitor target voltage threshold. The predetermined supercapacitor target voltage threshold may be lower than the maximum rated voltage of the assembly of one or more supercapacitor modules. The controller may be configured to instruct the rechargeable power source to supply charge to the assembly of one or more supercapacitor modules at a predetermined threshold current for battery balancing. The controller may be configured to disconnect the rechargeable power source from the assembly of one of more supercapacitor modules, such that the rechargeable power source experiences periods of low current drain where no charge is supplied to the assembly of one or more supercapacitor modules.

The load handling device may further comprise an energy recovery circuit to divert regenerated energy from the driving mechanism and/or the lifting drive assembly to the assembly of one or more supercapacitor modules. The energy recovery circuit may comprise a diode or transistor.

The assembly of one or more supercapacitor modules may have a lower internal resistance than the rechargeable power source.

The electrical loads may comprise a first portion and a second portion, where the first portion of the electrical load may comprise motive power loads and the second portion of the electrical load may comprise non-motive power loads. The rechargeable power source may be configured to supply charge to the non-motive power loads.

The assembly of one or more supercapacitor modules may be configured as a primary power supply for the load handling device, and the rechargeable power source may be configured as an auxiliary power supply. The controller may be configured to instruct the rechargeable power source to provide backup power to the electrical loads when the voltage across the assembly of one or more supercapacitor modules is below a predetermined supercapacitor voltage threshold.

The assembly of one or more supercapacitor modules may be distributed around the outside of a container-receiving recess within the vehicle body of the load handling device, between an outer wall and an inner wall of the load handling device.

The assembly of one or more supercapacitor modules may comprise capacitors, supercapacitors, ultracapacitors, lithium capacitors, electrochemical double layer capacitors, electric double layer capacitors, pseudocapacitors, or hybrid capacitors.

The rechargeable power source may comprise lithium ion batteries, lithium-ion polymer batteries, lithium-air batteries, lithium-iron batteries, lithium-iron-phosphate batteries, lead-acid batteries, nickel-cadmium batteries, nickel-metal hydride batteries, nickel-zinc batteries, sodium-ion batteries, sodium-air batteries, thin film batteries, or smart battery carbon foam-based lead acid batteries.

Another aspect of the invention is a storage system comprising a grid framework supporting a pathway arranged in a grid pattern above stacks of containers, and a plurality of load handling devices as defined herein. The storage system may further comprise one or more supercapacitor charge stations located at a grid location above an access point, in which the assembly of one or more supercapacitor modules on the load handling device is charged by one of the one or more supercapacitor charge stations during lifting or lowering operations. The one or more supercapacitor charge stations may be high-rate inductive supercapacitor charge stations. The controller on the load handling device may be configured to instruct the assembly of one or more supercapacitor modules to charge the rechargeable power source. The controller may be configured to instruct the one or more supercapacitor modules to supply charge to the rechargeable power source at the predetermined threshold current for battery balancing. The one or more supercapacitor charge stations may enable the load handling device to maintain the rechargeable power source voltage level above a predetermined threshold voltage for powering the electrical loads.

A further aspect of the invention is a fulfilment centre, comprising the storage system as described herein. A temperature inside the fulfilment centre may be any of an ambient temperature at or above 4° C.; a refrigerated temperature between substantially 0° C. to substantially 4° C.; or a frozen temperature between substantially −25° C. to substantially 0° C.

Connecting the supercapacitor between a rechargeable power source and an electrical load enables the energy storage system to enjoy the advantages of both high energy density and high power density, while mitigating the disadvantages. This is especially true when the rechargeable power source is a high energy density battery. The supercapacitor undergoes charge/discharge cycles caused by acceleration/deceleration demands from the electrical loads, protecting the battery from these cycles and therefore improving battery life. Improved battery life results in reduced operational costs and reduced downtime because the batteries need to be replaced less often. Reduced battery cycling means reduced battery energy losses and less useful energy being wasted as heat. This is particularly important when the load handling devices are operating in fulfilment centres of refrigerated or frozen goods, where the temperature of the fulfilment centre is kept low. In this situation, not only does any rejected heat from the load handling devices represent wasted energy, but greater energy consumption is required to keep the fulfilment centre temperature low.

### BRIEF DESCRIPTION OF FIGURES

Further features and aspects of the present invention will be apparent from the following detailed description of an illustrative embodiment made with reference to the drawings, in which:

FIG. 1 is a schematic diagram of a grid framework structure according to a known system.

FIG. 2 is a schematic diagram of a top down view showing a stack of bins arranged within the framework structure of FIG. 1.

FIG. 3 is a schematic diagram of a system of a known load handling device operating on the grid framework structure.

FIG. 4 is a schematic perspective view of the load handling device showing the lifting device gripping a container from above.

FIGS. 5(a) and 5(b) are schematic perspective cutaway views of the load handling device of FIG. 4 showing (a) the container receiving space of the load handling device and (b) a container accommodated within the container receiving space of the load handling device.

FIG. 6 is a Ragone plot, showing the energy density and power density of different energy storage devices.

FIG. 7 is a circuit diagram showing a rechargeable power source and supercapacitor connected in parallel with electrical loads.

FIG. 8 is a circuit diagram featuring a source DCDC converter between the rechargeable power source and supercapacitor, and a load DCDC converter between the supercapacitor and electrical loads.

FIG. 9 is a circuit diagram featuring buck and boost DCDC converters.

FIG. 10 is a schematic diagram of a PID controller for a boost converter.

FIG. 11 is a circuit diagram featuring an energy recovery circuit for directing recovered energy into the supercapacitor.

FIG. 12 is a circuit diagram featuring non-motive power loads drawing power from the rechargeable power source.

FIG. 13 is a circuit diagram illustrating the direction of current flow during a deceleration event.

FIG. 14 is a circuit diagram illustrating the direction of current flow during a deceleration event, where the rechargeable power source is charging the supercapacitor.

FIG. 15 is a circuit diagram illustrating the direction of current flow while the load handling device is idle.

FIG. 16 is a circuit diagram illustrating the direction of current flow while the load handling device is idle, where the rechargeable power source is charging the supercapacitor.

FIG. 17 is a circuit diagram illustrating the direction of current flow during an acceleration event.

FIG. 18 is a circuit diagram illustrating the direction of current flow during an acceleration event, where the rechargeable power source is charging the supercapacitor.

FIG. 19 illustrates transient currents caused by lowering and raising of the grabber device when depositing and retrieving a storage container.

FIG. 20 is a schematic diagram of the load handling device showing the gap between inner and outer walls of the vehicle body.

FIG. 21 is a schematic diagram of the load handling device showing supercapacitor modules distributed within the gap between inner and outer walls of the vehicle body.

FIG. 22 compares voltage and state of charge from battery voltage measurements, manufacturer data, and the battery fuel gauge.

FIG. 23 illustrates how battery fuel gauge measurements become inaccurate after a period of continuous operation.

FIG. 24 is a circuit diagram showing a rechargeable power source connected in parallel with electrical loads and a filter circuit.

FIG. 25 is a circuit diagram showing a rechargeable power source connected in parallel with electrical loads and a filter circuit, with a filter DCDC converter between the filter circuit and the electrical loads.

FIG. 26 is a circuit diagram showing a rechargeable power source connected in parallel with electrical loads and a filter circuit, with a filter DCDC converter between the filter circuit and the electrical loads and a source DCDC converter between the rechargeable power source and the filter circuit.

FIG. 27 illustrates some embodiments of filter circuits: a) RC circuit b) RL circuit c) RLC circuit d) Butterworth filter e) active filter circuit using operational amplifier.

FIG. 28 illustrates the voltage gain of an operational amplifier plotted against frequency.

FIG. 29 illustrates transient currents caused by lowering and raising of the grabber device when depositing and retrieving a storage container.

FIG. 30 illustrates Fourier transforms of the current through the rechargeable power source.

FIG. 31 illustrates a simulation model of a simple RC circuit.

FIG. 32 illustrates a) the load current as in FIG. 29 b) the current with a 20 Hz filter circuit c) the current with a 7 Hz filter circuit.

FIG. 33 compares a) the load current with the current with a 20 Hz filter circuit b) the load current with the current with a 7 Hz filter circuit.

FIG. 34 illustrates a discharge curve for a lithium-ion battery cell.

FIG. 35 illustrates the shape of the discharge curve for a battery and a supercapacitor.

FIG. 36 illustrates the power demand of a load handling device when moving on the storage grid.

FIG. 37 illustrates a simple circuit diagram with a supercapacitor 102 connected in series with a rechargeable power source 100.

FIG. 38 illustrates a multi-cell battery connected in series with an assembly of supercapacitors in parallel, with multiple electrical loads.

FIG. 39 illustrates a circuit diagram with a controller directing charge from the rechargeable power source to the supercapacitor.

FIG. 40 illustrates a circuit diagram with a controller directing recovered energy to the supercapacitor.

FIG. 41 is a detailed view of one embodiment of a controller and DCDC converter.

FIG. 42 illustrates a supercapacitor protection circuit.

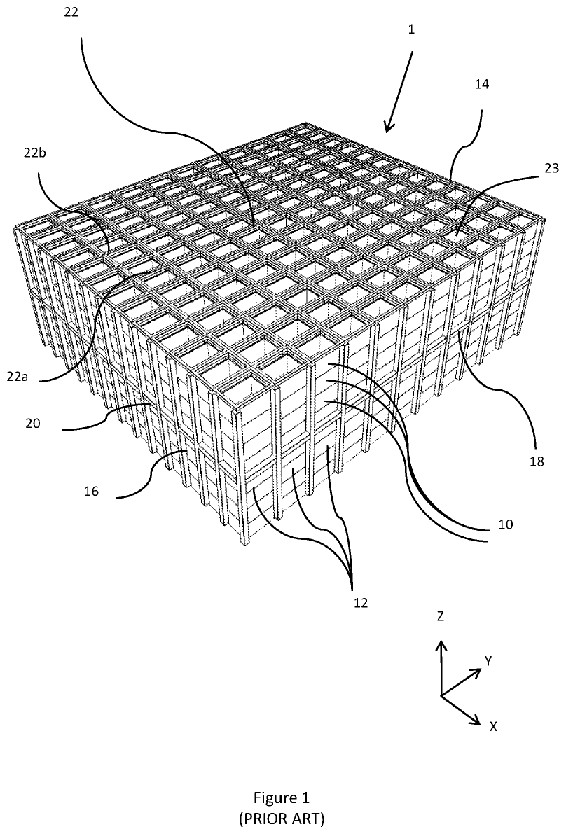

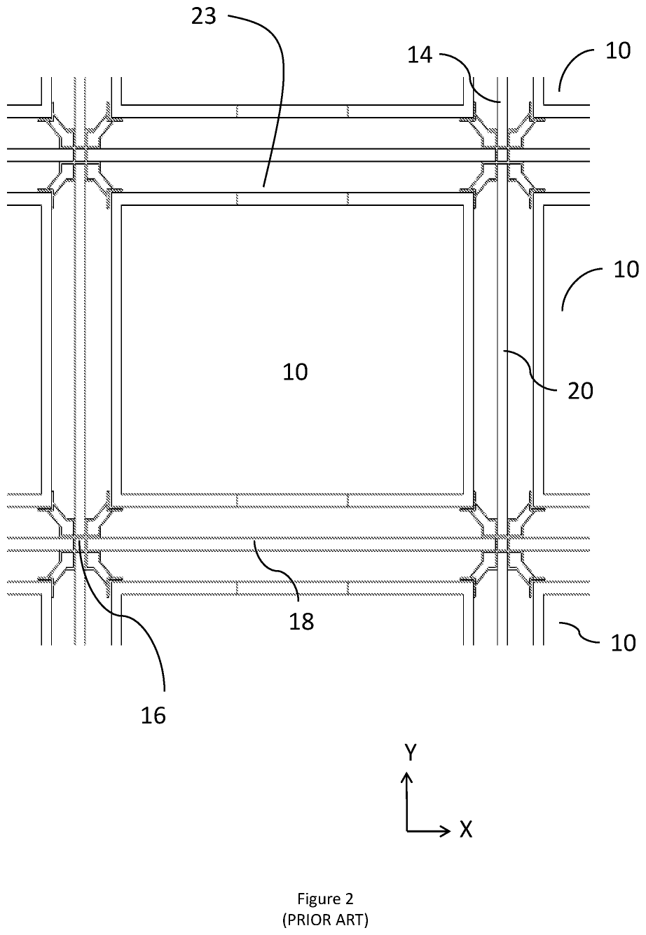

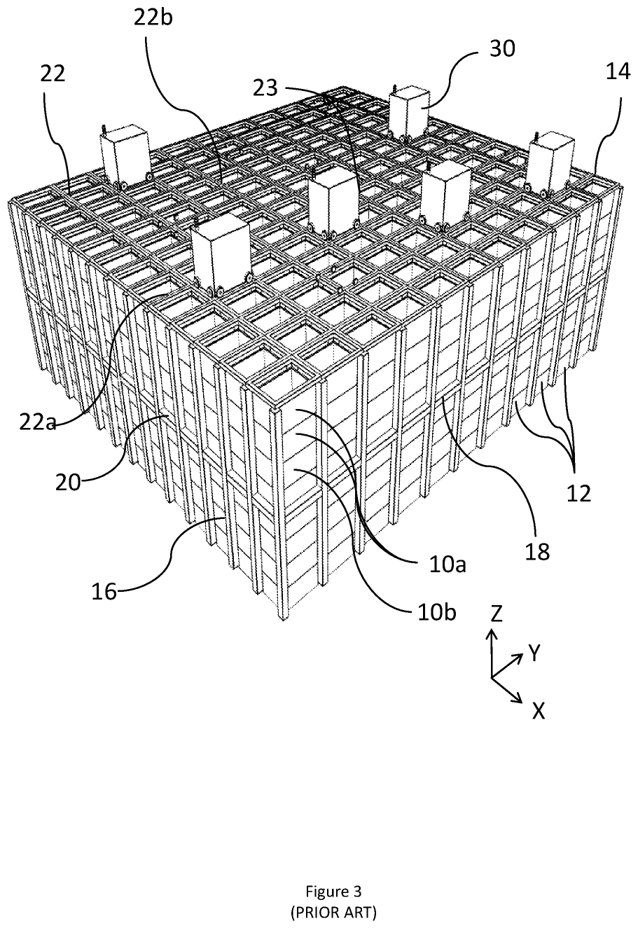

### DETAILED DESCRIPTION OF INVENTION

### Rechargeable Power Source Configured to Provide Power to Assembly of One or More Supercapacitor Modules

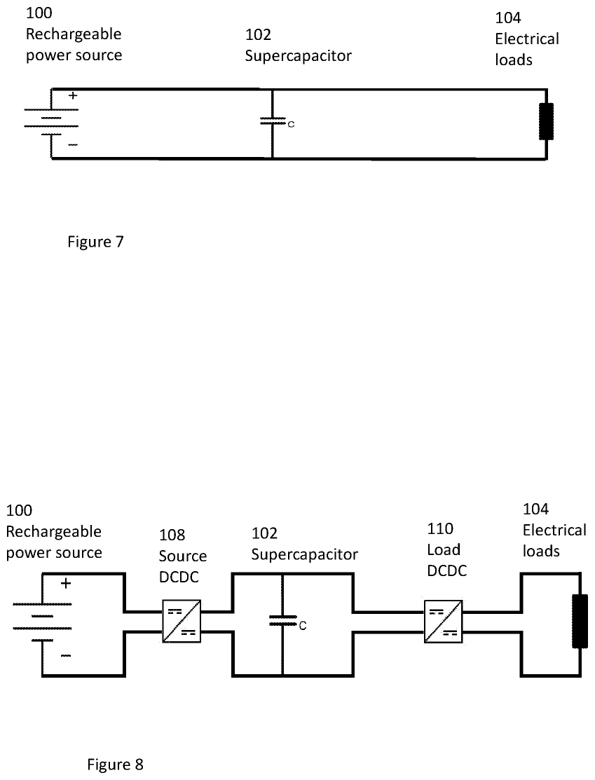

FIG. 7 is a circuit diagram showing a rechargeable power source 100 connected in parallel with a supercapacitor 102 and electrical loads 104. The electrical loads 104 may comprise one or more motors which enable movement of the vehicle in the X and Y directions respectively along the rails by driving sets of wheels 34 and 36, and/or one or more motors that drive a lifting device or crane mechanism to lift a storage container from above. The supercapacitor 102 is connected in between the rechargeable power source 100 and the electrical loads 104, such that the rechargeable power source can provide power to or receive power from the supercapacitor, and the supercapacitor can provide power to or receive power from the electrical loads.

For ease of illustration the circuit diagram in FIG. 7 shows the rechargeable power source 100 as a single battery cell, and the supercapacitor 102 as a single supercapacitor. It will be appreciated that the rechargeable power source is not limited to a battery, and a battery may comprise an assembly of one or more battery cells rather than a single battery cell.

Similarly the supercapacitor 102 may comprise an assembly of one or more supercapacitor modules rather than a single supercapacitor module.

### DCDC Converters

The circuit may additionally comprise a source DCDC converter 108 between the rechargeable power source 100 and the supercapacitor 102. The purpose of the source DCDC converter 108 is to convert the voltage across the rechargeable power source to a different voltage across the supercapacitor.

The source DCDC converter 108 between the between the rechargeable power source 100 and the supercapacitor 102 may comprise a boost converter or a buck converter. Advantageously, the source DCDC converter 108 between the rechargeable power source 100 and the supercapacitor 102 may comprise a boost converter. The advantage of a higher voltage across the supercapacitor is that the supercapacitor can store more energy. Also a higher voltage (and therefore lower current) results in lower resistive power losses (P=I\hat{ }2 R) and therefore reducing the amount of useful energy converted into heat.

The circuit may additionally comprise a load DCDC converter 110 between the supercapacitor 102 and the electrical loads 104. The purpose of the load DCDC converter 108 between the rechargeable power source 100 and the supercapacitor 102 is convert the voltage across the supercapacitor to a different voltage across the electrical loads.

The load DCDC converter 110 between the supercapacitor 102 and the electrical loads 104 may comprise a boost converter or a buck converter.

FIG. 8 is a circuit diagram showing both the source DCDC converter 108 between the rechargeable power source 100 and the supercapacitor 102, and the load DCDC converter 110 between the supercapacitor 102 and the electrical loads 104. It will be appreciated that, although FIG. 8 shows both DCDC converters, the invention encompasses a circuit including the source DCDC converter 108 but not the load DCDC converter 110, and the load DCDC converter 110 but not the source DCDC converter 108.

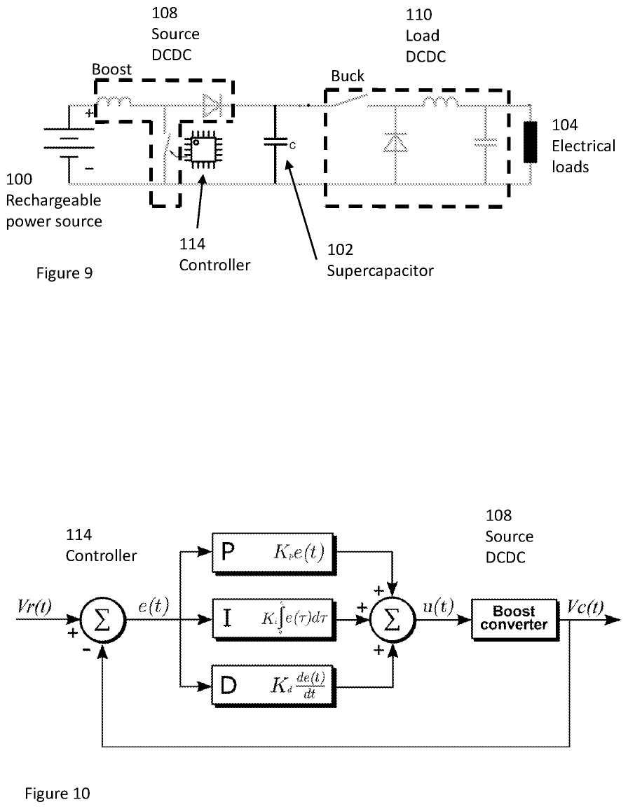

Advantageously, the source DCDC converter 108 between the rechargeable power source 100 and the supercapacitor 102 is a digitally-controlled boost converter, and the source DCDC converter 110 between the supercapacitor 102 and the electrical loads 104 is a buck converter. FIG. 9 is a circuit diagram where the source DCDC converter 108 between the rechargeable power source 100 and the supercapacitor 102 is a boost converter, and the load DCDC converter 110 between the supercapacitor 102 and the electrical loads 104 is a buck converter. A controller 114 may be used to keep the supercapacitor voltage within a desired range with minimal current flow from the rechargeable power source.

The advantage of the source DCDC converter 108 between the rechargeable power source 100 and the supercapacitor 102 being a boost converter is that the supercapacitor voltage will never drop below the rechargeable power source voltage. The load DCDC converter can therefore be powered by a simple buck converter to power the electrical loads 104. Energy recovered from deceleration events can be directed to the supercapacitor by an energy recovery circuit 112. The circuitry can be kept as simple as a power diode controlling the current flow from the electrical loads to the supercapacitor.

### Control of Supercapacitor Charging

An important issue to be considered is how to control the state of charge of the supercapacitor. If the supercapacitor were to be fully charged, then after a deceleration event, recovered energy would not be able to be stored in the supercapacitor. In this case the recovered energy would need to either be directed to the rechargeable power source (thus contributing to battery aging if the rechargeable power source is a battery) or dissipated as heat.

FIG. 10 shows one possible embodiment of the controller 114 as a PID controller. One option is for the controller 114 to allow the rechargeable power source to charge the supercapacitor only when the supercapacitor's charge is below a predetermined supercapacitor target voltage threshold. This could be done by measuring the voltage Vc across the supercapacitor, and allowing the rechargeable power source to charge the supercapacitor only when the supercapacitor's voltage is below the predetermined supercapacitor target voltage threshold. The predetermined supercapacitor target voltage threshold Vr is compared with the instant supercapacitor voltage Vc, and the controller 114 adjusts its output accordingly.

### Energy Recovery

During deceleration events, it is possible for kinetic energy to be recovered from deceleration of the load handling device and stored in the supercapacitor for later use.

The energy storage system of the load handling device must be able to receive power from the driving mechanism during a deceleration event, in which the load handling device decelerates from its maximum speed in the X or Y direction until it come to rest in a different grid position. The driving mechanism may comprise one or more electrical motors, which act as generators during a deceleration event to convert the kinetic energy of the load handling device into electrical energy, which can be stored in the supercapacitor for later use.

The energy storage system of the load handling device must be able to receive power from the lifting mechanism during a deceleration event, in which the grabber device is lowered to a lower vertical position in the storage grid. As the grabber is lowered, the potential energy from its higher vertical starting position is converted into kinetic energy. The lifting drive assembly may comprise one or more electrical motors, which act as generators during a deceleration event to convert the kinetic energy of the descending platform into electrical energy, which can then be stored in the supercapacitor for later use.

It will be appreciated that during a lowering operation when the grabber device is gripping a storage container, more energy can be recovered since the storage container's mass means that there is more potential energy to be recovered from the higher vertical starting position of the grabber device and storage container.

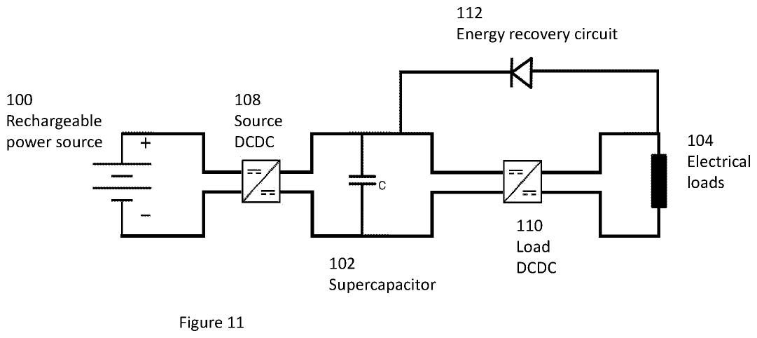

The recovered energy can be diverted into the supercapacitor 102 by means of an energy recovery circuit 112, as shown in FIG. 11. The purpose of the energy recovery circuit 112 is to direct the current into the supercapacitor 102. This is advantageous because recovered energy directed into the rechargeable power source would increase the number of charge-discharge cycles, and accelerate battery aging if the rechargeable power source is a battery. The energy recovery circuit may comprise one or more diodes or transistors.

The assembly of one or more supercapacitor modules may have a lower internal resistance than the rechargeable power source, in order to ensure that the recovered energy is directed to the supercapacitor rather than to the rechargeable power source.

### Sizing Supercapacitor to Receive and Store Recovered Energy

The predetermined supercapacitor target voltage threshold can be chosen such that it is lower than the supercapacitor's maximum rated voltage, and so that the difference between the predetermined supercapacitor target voltage threshold and the supercapacitor's maximum rated voltage is sufficient for the supercapacitor to accept recovered energy from one or more deceleration events. Also the supercapacitor's power rating can be chosen such that the power rating is sufficient to receive power from a deceleration event.

The assembly of supercapacitor modules may be sized such that the difference between the predetermined supercapacitor target voltage threshold and the supercapacitor's maximum rated voltage is sufficient to receive and store energy from one deceleration event.

Alternatively, the assembly of supercapacitor modules may be sized such that the difference between the predetermined supercapacitor target voltage threshold and the supercapacitor's maximum rated voltage is sufficient to receive and store energy from a plurality of deceleration events. For example, if the load handling device is required to move to a different grid cell in the Y direction and deposit a storage container, this operation comprises four acceleration/deceleration events: accelerating to maximum speed in the Y direction (acceleration event); decelerating in the Y direction to come to rest above the target grid cell (deceleration event); lowering the grabber device and storage container from the container receiving space of the load handling device to a lower vertical position to deposit the storage container (deceleration event); and raising the grabber device back up to the load handling device (acceleration event). In this sequence of events there are two consecutive deceleration events. Sizing the assembly of one or more supercapacitor modules such that the difference between the predetermined supercapacitor target voltage threshold and the supercapacitor's maximum rated voltage is sufficient to receive and store energy from both deceleration events means that the supercapacitor alone can be used for this operation, therefore reducing the number of power cycles required in the rechargeable power source, and potentially extending its life. In general it is an advantage for the supercapacitor energy capacity to be sufficient for more than one typical deceleration event, so under normal operation the rechargeable power source does not have to receive energy from acceleration events. Reversing the direction of current through the rechargeable power source can accelerate the aging process and reduce its life, especially if the rechargeable power source is a battery.

Sizing the supercapacitor such that the difference between the predetermined supercapacitor target voltage threshold and the supercapacitor's maximum rated voltage is sufficient to receive and store energy from a plurality of deceleration events is advantageous because it ensures that the energy flow between the rechargeable power source and supercapacitor is in one direction only during normal operation on the grid, even if there is an unexpectedly high deceleration event. The supercapacitor effectively fulfils the charge-discharge cycles from acceleration/deceleration events, protecting the rechargeable power source from the aging effect of these cycles. Instead of undergoing charge-discharge cycles for all acceleration/deceleration events, as would happen if the rechargeable power source were the sole power source in the energy storage system, the rechargeable power source instead only needs to provide a constant “top-up” of energy to the supercapacitor at a low power. This has the additional advantage that it is easier to provide a smooth and constant current profile for the rechargeable power source.

If the source DCDC converter 108 between the rechargeable power source and supercapacitor is a boost converter, the predetermined supercapacitor target voltage threshold can be higher than the rechargeable power source voltage. This has the advantage that the supercapacitor 102 can store more energy, since the energy storage capacity is proportional to the voltage squared.

One option is to set the supercapacitor's minimum voltage to be no lower than the rechargeable power source voltage. This has the advantage that the load DCDC converter 110 can be a simple buck converter to power the electrical loads 104. Also if the supercapacitor's voltage is no lower than the voltage across the electrical loads, the energy recovery circuit 112 can be kept as simple as a power diode. The disadvantage of this option is that only a part of the supercapacitor's voltage range can be used.

Allowing the supercapacitor's voltage to drop below the rechargeable power source voltage, though it does allow more of the supercapacitor's range to be used, would mean that more complex electronics are required rather than a simple boost converter between the rechargeable power source and the supercapacitor. Also if the supercapacitor's voltage were lower than the voltage across the electrical loads, the energy recovery circuit 112 would need to be more complex in order to avoid over-voltage of the supercapacitor. Voltages that exceed the supercapacitor's maximum rating will reduce cell operating life and eventually lead to failure.

For example, if the rechargeable power source voltage and the electrical loads are both nominally 48V, the predetermined supercapacitor target voltage threshold can be set to 60V. The supercapacitor can be chosen such that the maximum rated voltage is 72V, so the supercapacitor will have sufficient energy storage capacity to store recovered energy from deceleration events. If the supercapacitor voltage is below 60V, the controller will allow the rechargeable power source to charge the supercapacitor. If the supercapacitor voltage is above 60V, the controller 114 will not allow the rechargeable power source to charge the supercapacitor. The supercapacitor will continue to provide energy for acceleration events until the voltage drops below 60V, after which the controller will permit the rechargeable power source to charge the supercapacitor again. In order to simplify the required electronics in the source DCDC converter 108 and the energy recovery circuit 112, the supercapacitor 102 may be limited to operating above a minimum operating voltage of 48V.

### Non-Motive Power Loads

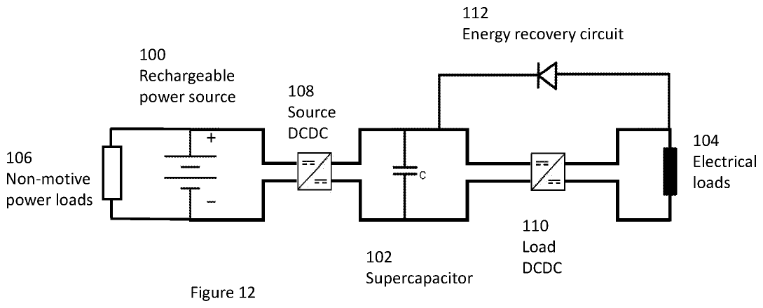

The electrical loads may comprise both motive and non-motive power loads. Motive power loads are due to the demands of the driving mechanism and/or the lifting drive assembly, and will vary depending on the movement of the load-handling device. Non-motive power loads are power loads for any function other than the motion of the load handling device, and could for example include power for communications with a storage grid control system. These non-motive power loads are always present irrespective of the movement of the load handling device. FIG. 12 illustrates the circuit diagram with non-motive power loads 106. The non-motive power loads may be powered by the rechargeable power source 100.

### Sizing Supercapacitor for Acceleration Events

The energy storage system of the load handling device must be able to provide power to the driving mechanism to enable the load handling device to move on the grid in the X and Y directions. A movement in the X or Y direction comprises an acceleration event, in which the load handling device starts from rest and accelerates until it reaches a maximum speed, followed by a deceleration event, in which the load handling device decelerates from the maximum speed until it come to rest in a different grid position. Each acceleration event is generally followed by a deceleration event.

The energy storage system of the load handling device must be able to provide power to enable the lowering and raising of the grabber device by the lifting drive assembly in order to retrieve or deposit a storage container. A lifting operation comprises a deceleration event, in which the grabber device is lowered from the load handling device to a lower vertical position within the grid framework, followed by an acceleration event, in which the grabber device grabs a storage container and raises it vertically upwards into the container receiving space in the load handling device. Similarly, a depositing operation comprises a deceleration event, in which the grabber device holding a storage container is lowered from the load handling device to a lower vertical position within the grid framework, where the storage container is deposited, followed by an acceleration event, in which the grabber is raised vertically upwards to the load handling device. Each deceleration event is generally followed by an acceleration event.

The assembly of supercapacitor modules may be sized such that the power rating is sufficient to provide power for one acceleration event.

Alternatively, the assembly of supercapacitor modules may be sized such that the power rating is sufficient to provide power for a plurality of acceleration events. For example, if the load handling device is required to retrieve a storage container and move it to a different grid cell in the X direction, this operation comprises four acceleration/deceleration events: lowering the grabber device (deceleration event); raising the grabber device and the storage container to place the storage container in the container receiving space (acceleration event); accelerating to maximum speed in the X direction (acceleration event); and decelerating to come to rest above the target grid cell (deceleration event). In this sequence of events there are two consecutive acceleration events. Sizing the assembly of one or more supercapacitor modules such that the power rating is sufficient to provide power for both acceleration events means that the supercapacitor alone can be used for this operation, therefore reducing the number of rechargeable power source power cycles required and potentially extending the life of the rechargeable power source. In general it is an advantage for the supercapacitor power to be sufficient for more than one typical acceleration event, so under normal operation the rechargeable power source does not have to provide power for acceleration events, and only needs to top up the supercapacitor if the charge drops below a given level. If there is an unexpectedly high acceleration, the rechargeable power source will still be protected from power cycles.

The supercapacitor can be sized such that it has sufficient power and energy available to complete the acceleration event requiring the most energy, which may be a move in the X or Y direction across the full length of the storage grid.

### Circuit Operation

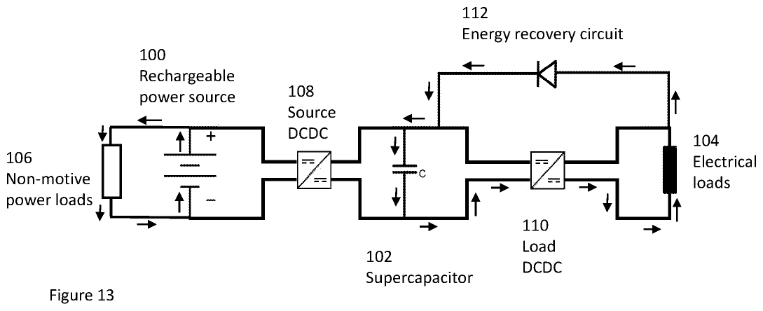

FIGS. 13-18 illustrate the operation of the circuit while the load handling device is under different conditions: during a deceleration event, during an idle period, and during an acceleration event. In each case the operation of the circuit is shown while the rechargeable power source is charging the supercapacitor, and while the rechargeable power source is not charging the supercapacitor. The arrows on the figures represent the direction of current flow.

FIG. 13 illustrates the operation of the circuit while the load handling device is undergoing a deceleration event. Energy is recovered from the electrical loads 104 (for example from the driving mechanism or lifting mechanism), and directed by the energy recovery circuit 112 to the supercapacitor 102. The rechargeable power source 100 provides power to the non-motive power loads 106. Effectively the circuit diagram is two separate circuits.

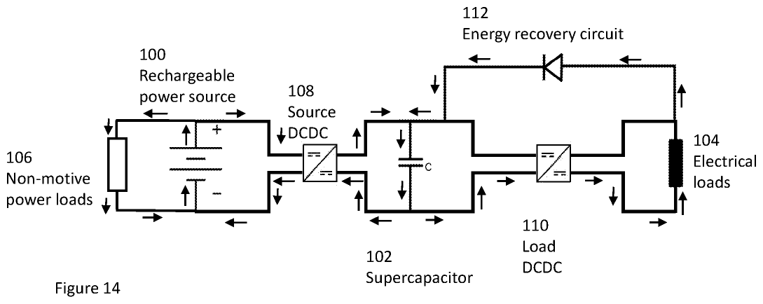

FIG. 14 illustrates the operation of the circuit while the load handling device is undergoing a deceleration event and the rechargeable power source is charging the supercapacitor. Energy is recovered from the electrical loads 104 (for example from the driving mechanism or lifting mechanism), and directed by the energy recovery circuit 112 to the supercapacitor 102. The rechargeable power source 100 provides power to the supercapacitor 102 and to the non-motive power loads 106. For this to happen, the supercapacitor power rating must be sufficient to receive power form both the energy recovery circuit and the rechargeable power source.

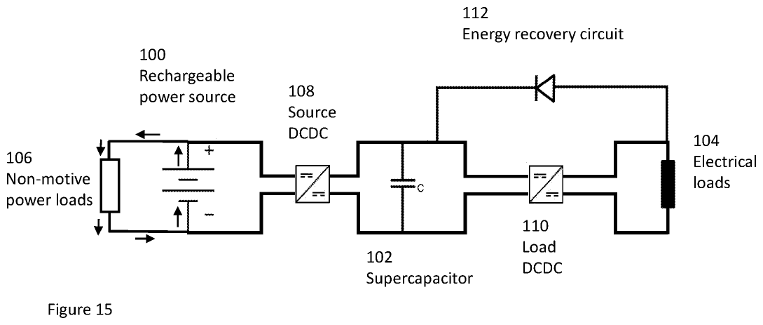

FIG. 15 illustrates the operation of the circuit while the load handling device is idle. The rechargeable power source 100 provides power to the non-motive power loads 106. The source DCDC converter 108 may be disconnected so that no power is provided to the supercapacitor 102.

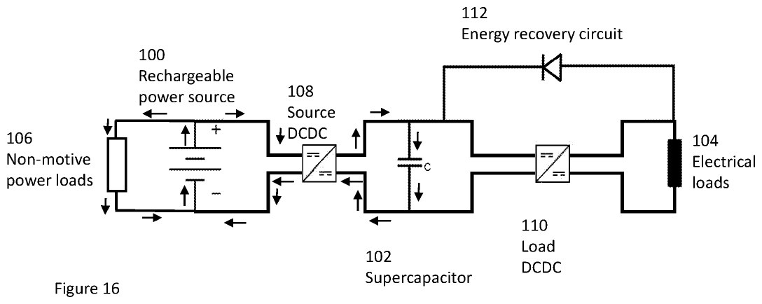

FIG. 16 illustrates the operation of the circuit while the load handling device is idle and the rechargeable power source is charging the supercapacitor. The rechargeable power source 100 provides power to the non-motive power loads 106 and the supercapacitor 102. The load DCDC converter 110 may be disconnected so that no power is provided to the electrical loads 104. The circuit may have an active mode in which acceleration of the load handling device is expected imminently, in which case the load DCDC converter 110 may be connected in preparation for providing power to the electrical loads 104.

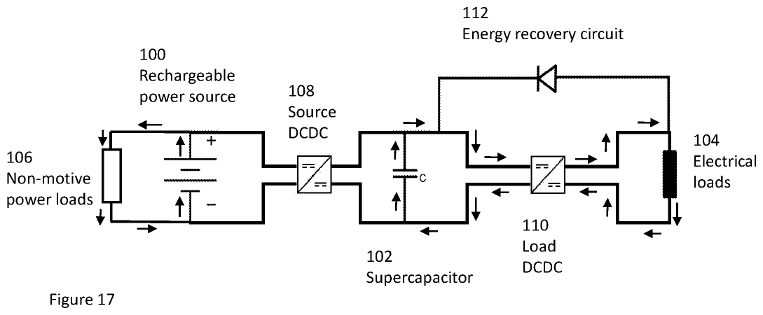

FIG. 17 illustrates the operation of the circuit while the load handling device is undergoing an acceleration event. Power is provided to the electrical loads 104 (for example to the driving mechanism or lifting mechanism) by the supercapacitor 102. The rechargeable power source 100 provides power to the non-motive power loads 106. Effectively the circuit diagram is two separate circuits.

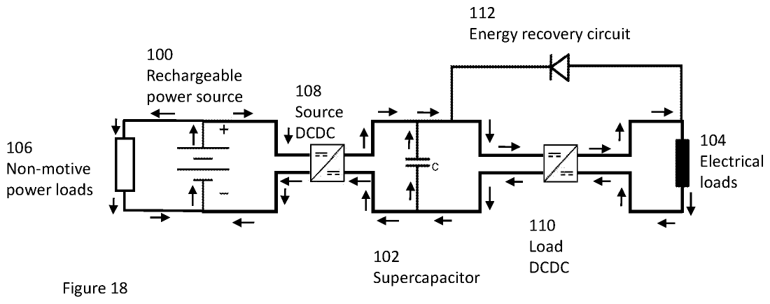

FIG. 18 illustrates the operation of the circuit while the load handling device is undergoing an acceleration event and the rechargeable power source is charging the supercapacitor. Power is provided to the electrical loads 104 (for example to the driving mechanism or lifting mechanism) by the supercapacitor 102. The rechargeable power source 100 provides power to the non-motive power loads 106. The rechargeable power source 100 can provide power to the supercapacitor 102 if the impedance of the electrical loads 104 is lower than impedance of the supercapacitor 102, otherwise the rechargeable power source 100 can provide power to the electrical loads.

### Rechargeable Power Source Provides Average Current

One of the main advantages of using the supercapacitor to provide power to the load handling device is that the supercapacitor experiences charge/discharge cycles instead of the rechargeable power source. The rechargeable power source is subject to the average current rather than cycles.

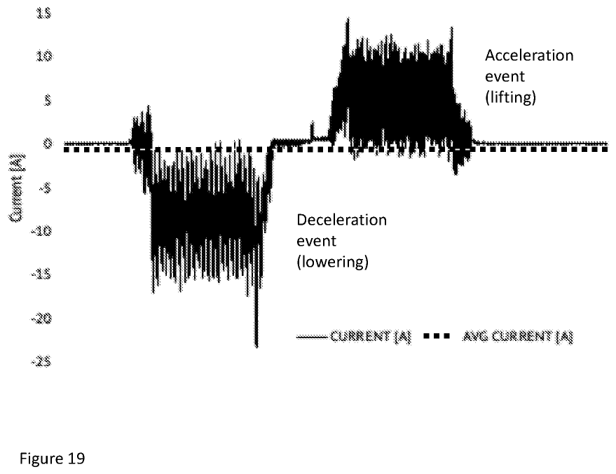

FIG. 19 is an illustration of the principle of using the supercapacitor. Current through the electrical loads is plotted against time, as a storage container weighing 15 kg is lowered to a depth of 12 grid cells in the grid storage system, and then raised again. The solid line represents the current provided to/recovered from the lifting drive assembly (the electrical loads). The graph shows first a deceleration event, in which the lifting drive assembly lowers a storage container from the load handling device's container receiving space into the storage grid, and kinetic energy is recovered from the storage container and converted into electrical energy by the lifting drive assembly (negative current). Next an acceleration event is shown, in which energy is provided to the lifting drive assembly in order to lift the storage container up to the top of the storage grid and place the storage container inside the load handling device's container receiving space (positive current). If the rechargeable power source alone were used to power the lifting drive assembly of the load handling device, the rechargeable power source would be subject to transient currents of up to 23 amps (decelerating) and 14 amps (accelerating). These surges in current, along with the transient nature of the current, comprise a large number of partial charge/discharge cycles which would accelerate the aging of the rechargeable power source. This is especially true if the rechargeable power source is a battery.

The dashed line in FIG. 19 represents the average current required by the electrical loads. The average current is around 1 amp (decelerating). If the supercapacitor placed between the rechargeable power source and the electrical loads acted as a perfect filter, the entire current signal including all of the transients would be taken by the supercapacitor, and the rechargeable power source would be subject to an average current of 1 amp. The removal of the transients means that the rechargeable power source is not subject to any charge-discharge cycles, significantly extending its expected lifetime. Supercapacitors are well suited to handle transients in current, since they have a high power density and do not suffer from premature aging from large numbers of charge-discharge cycles.

The use of the assembly of one or more supercapacitor modules also improves the efficiency of the energy storage system. Power loss is proportional to the current squared, so a lower current in the rechargeable power source results in a much reduced power loss. In the scenario described above and shown in FIG. 19, the heat generated inside the rechargeable power source during the lowering and lifting of a storage container weighing 15 kg to a depth of 12 grid cells is 230 J/Ohm. Using an assembly of one or more supercapacitor modules to power the lowering and lifting of the storage container would reduce this generated heat in the rechargeable power source to 2.8 J/Ohm (calculated using the average current). This is a reduction in generated heat by a factor of 82.

As well as improving efficiency, reducing power losses is particularly important when the load-handling device is handling chilled or frozen goods in a fulfilment centre, and the fulfilment centre needs to be kept at a low temperature. Rejected heat from the rechargeable power source in the load handling device means that the fulfilment centre's cooling system needs to expend more energy to maintain the required low temperature.

Supercapacitor as Primary Power Supply with Auxiliary Power Supplied by Rechargeable Power Source

In one embodiment of the invention, the supercapacitor 102 can be used as the primary power supply for the load handling device, with auxiliary power supplied by the rechargeable power source 100. This enables the load handling device to operate using the supercapacitor as the main power source, and therefore benefit from the advantages of fast charging of the supercapacitor at supercapacitor charging stations.

When the rechargeable power source is a battery, the relatively long charging time of the battery can be as long as a couple of hours, which represents a significant downtime during which a load handling device remains inactive or inoperative on the grid framework structure. Where a number of load handling devices are operative on the grid framework to fulfil customer orders within a given time slot, having one or more load handling devices remain idle for a significant amount of time has a detrimental impact on the ability of a fulfilment centre or distribution warehouse to fulfil orders in a timely manner. This is particularly the case where the load handling device contributes to a logistical system that provides home delivery of goods to a customer's premises upon receipt of an order of goods. Here, delivery information containing delivery addresses is used by online retailers such as Amazon and UK's Ocado to deliver goods to the customer's delivery address. To mitigate such a problem, online retailers such as UK's Ocado provide a buffer of load handling devices operative on the grid framework to cater for load handling devices that remain idle for charging. In an extreme case, time slots for the delivery of orders are extended to cater for this downtime. Using a supercapacitor as the primary power source negates the disadvantages of slow battery charging, reduces downtime, and contributes to the efficient fulfilment of customer orders.

Batteries which are largely based on lithium-Ion, nickel-cadmium, nickel-metal hydride, or lithium-ion polymer battery technologies rely on a chemical reaction to store electrical energy. The effectiveness of these batteries diminishes after repeated charging due to the breakdown of the lithium ion cells, and therefore the ability of the battery to store charge for a prolonged period of time diminishes over time.

Charging stations for supercapacitors typically operate at a higher current than charging stations for batteries, because supercapacitors have a higher power density so can accept charge at a higher power (which also has the advantage of faster charging). The storage grid may be provided with two types of charging station, one at a higher power rating/higher current for charging supercapacitors and one at a lower power rating/lower current for charging rechargeable power sources.

The load handling device may be controlled by a control system monitoring the charge level of the energy storage system. The control system can determine whether the energy storage system of a load handling device requires charging, and directs the load handling device to move to a charge station if this charge level falls below a predetermined threshold charge level. With a dual power source, the control system can determine whether the supercapacitor or the rechargeable power source needs to be charged, select an appropriate charging station, and direct the load handling device to move to the selected charging station on the storage grid.

Alternatively, a single type of combined charging station can be provided, which can be configured to provide either a low current (for slow charging of the rechargeable power source) or a high current (for fast charging of supercapacitors). A control system determines when the energy storage system of a load handling device requires charging, determines whether the supercapacitor or the rechargeable power source needs to be charged, selects an appropriate combined charging station, directs the load handling device to move to the selected charging station on the storage grid, and determines whether the high charging current or low charging current should be used.

The charging stations can be inductive wireless charging stations.

In this embodiment of the invention the assembly of one or more supercapacitors is the primary power supply, so the majority of charging will be fast charging of the assembly of one or more supercapacitor modules. Rechargeable power source charging will be needed only infrequently, when the rechargeable power source is depleted.

Auxiliary Power from Rechargeable Power Source after Grid Downtime

On occasion the entire storage system needs to be offline for a short period (known as grid downtime) in order to carry out maintenance activities or to resolve a problem with a load handling device. This could cause a problem if load handling devices were solely powered by a supercapacitor as the main power source. Supercapacitors have a high self-discharge rate, and typically after one hour of inactivity the supercapacitor would have partially discharged to below a predetermined threshold voltage for powering the electrical loads, where the supercapacitor can no longer provide the required power to allow the load handling device to move on the storage grid. After the grid downtime is over and the load handling devices are reactivated, the load handling devices may not be able to return to a charging station under their own power. The load handling devices would need to be retrieved from their positions on the grid and taken to a charging station before they can become operational again, which would extend the grid downtime period.

This issue is solved by using the rechargeable power source as backup power when the supercapacitor as primary power supply has been discharged, especially when the rechargeable power source is a battery. Batteries have the advantage of a low self-discharge rate, so after a period of inactivity the battery will not have discharged significantly. After grid downtime for maintenance activities when the supercapacitor state of charge has dropped to a level where it cannot provide the required power, the rechargeable power source will be able to provide backup power to the electrical loads to enable movement of the load-handling device.

The load handling device can switch to operating on power from the rechargeable power source 100 when the supercapacitor 102 is partially or fully discharged, and thus eliminates the risk of the load handling device running out of power and being stranded on the grid, necessitating downtime in order for the load handling device to be retrieved and taken to a charging station.

### Supercapacitor in Low Temperature Environments

Supercapacitors outperform battery technology in low temperature environments, which makes the load-handling device with supercapacitor as primary power supply particularly well-suited to these operating conditions.

The load handling devices may be operating in fulfilment centres where the temperature is kept low, for example when fulfilling customer orders of chilled or frozen goods. Not only does any rejected heat from the energy storage system of the load handling device represent wasted energy, but also necessitates a greater energy consumption to keep the fulfilment centre temperature low.

Table 2 shows the performance of a bank of Li-ion batteries powering the load handling device on the grid framework structure.

TABLE 2
Battery performance of Li-ion battery
in a load handling device

| Parameter | Value | | Status |
|---|---|---|---|
| Operating cycle | 4 | hours | Discharge |
| | 12-18 | minutes | Charge |
| Power output of | 400 | W | Average |
| electrical loads | 600 | W | Peak |
| | 96 | W | Idle |

Typically, the Li-ion battery requires a charge of 15 minutes for every 4 hours of discharge. During operation on the grid framework structure over a four hour period, the power on the electrical loads reaches a peak of 600 W, and 96 W when idle as power is consumed through communication via a communication device between the controller (control unit) in the load handling device and a central control system. The average power consumed by the electrical loads is taken to be 400 W over a 4 hour period, corresponding to an energy consumption of 100 Wh per operating cycle. The energy storage system on the load handling device would need to store at least an energy of 100 Wh when fully charged. The Li-ion battery has a lifetime of 3 years at ambient controlled temperature (10° C.-30° C.) and 0.5 years at chilled temperature (0.5° C.).

In contrast to Li-ion batteries, supercapacitors do not suffer from the issue of reduced lifetime when operating at lower temperatures. Supercapacitors are typically rated for operating temperatures down to −40° C., and do not suffer from any decrease in performance.

The load-handling devices may be required to operate in a low temperature environment when the storage system is for chilled or frozen goods. In particular the storage system may be located in a fulfilment centre with a chilled or frozen temperature environment, and the load handling devices would need to be able to operate in this environment. Frozen temperature covers a range between substantially −25° C. to substantially 0° C., and chilled temperature covers a range between substantially 0° C. to substantially 4° C. Supercapacitors will therefore typically be within their rated operating temperature in a chilled or frozen temperature environment.

As an example, Table 3 shows the calculated charge currents for different desired charging times and discharging times at 48 volts, applied to a commercially available supercapacitor module charged with an initial energy of 100 Wh. The average power consumption over a four hour period as shown in Table 2 for a Li-ion battery is considered to be 400 W. The charge times shown in the table (from 5 to 30 seconds) for the supercapacitor are much faster than for the Li-ion battery (typically 15 minutes).

Table 4 shows the equivalent energy used for the different discharge times, and the equivalent depth of discharge of the supercapacitor, assuming an initial charge of 100 Wh. The average power consumed by a Li-ion battery in a load handling device as shown in Table 2 is 400 W. To get the same power from a supercapacitor initially charged to provide 100 Wh, the supercapacitor would have to fully discharge every 15 minutes with a depth of discharge of 100%. Likewise, a discharge time of 5 minutes would represent a depth of discharge of 33% and an equivalent energy of 33 Wh.

Depending on an operation of the load handing device on the grid framework structure and thus, the power consumed by the load handling device in carrying out the mission on the grid framework structure, short bursts of energy can be delivered to the supercapacitor modules by visiting one or more supercapacitor charge stations to top up the supercapacitor modules sufficient to allow the load handling device to complete the operation. In comparison to the time in carrying out the mission on the grid framework structure, the charging time of the bank of supercapacitor modules represents a small proportion of this time. Since the charge time is relatively short (of the order of seconds) and since the supercapacitor can tolerate multiple charging cycles, the load handling device can visit multiple charge stations during an operation on the grid framework structure. For example, the supercapacitor can cycle over 290K times at a depth of discharge of 100%, which equates to a service life of about 8 years, which is far longer than the service life of a typical battery.

TABLE 3
Charge currents for different charging and discharging times at 48 volts
Current (amps)

| Discharge time | | Charge time (seconds) | | | | | |
|---|---|---|---|---|---|---|---|
| (minutes) | | 5 s | 10 s | 15 s | 20 s | 25 s | 30 s |
| 5 | mins | 500 | 250 | 167 | 125 | 100 | 83 |
| 10 | mins | 1000 | 500 | 333 | 250 | 200 | 167 |
| 12 | mins | 1200 | 600 | 400 | 300 | 240 | 200 |
| 15 | mins | 1500 | 750 | 500 | 375 | 300 | 250 |

TABLE 4
Energy used (Wh) where the average power consumption is 400 W.

| Discharge time (mins) | Energy used (Wh) | Depth of Discharge | Cycles |
|---|---|---|---|
| 5 mins | 33 | 33% | 871 k |
| 10 mins | 67 | 67% | 436 k |
| 12 mins | 80 | 80% | 363 k |
| 15 mins | 100 | 100% | 290 k |

### Distribution of Supercapacitor Modules to Lower the Centre of Mass of the Load Handling Device

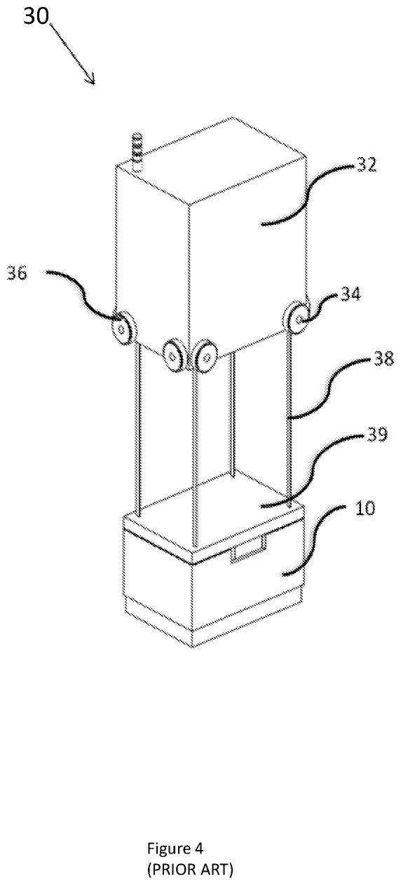

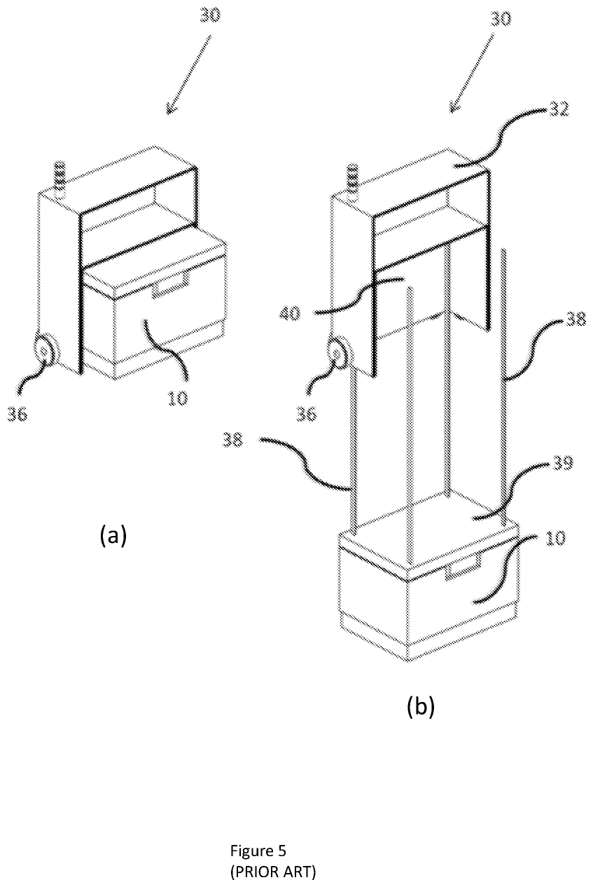

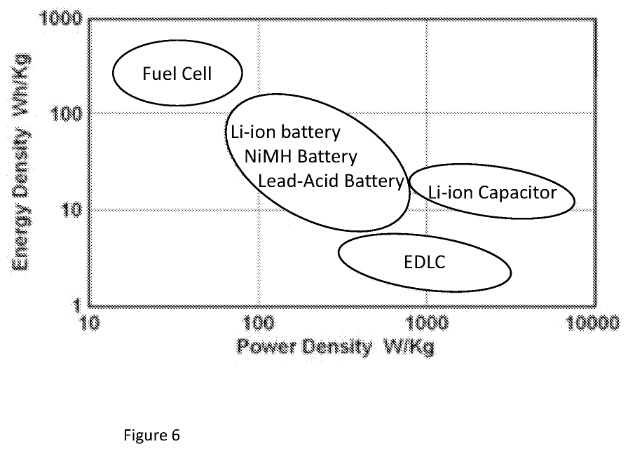

In one embodiment of the invention, the load handling devices occupy only one grid space or grid cell of the grid framework structure (as shown in FIGS. 4 and 5). This has the advantage that a greater number of load handling devices can be active on the grid at any given time. However, the load-handling device shown in FIG. 5 with a container-receiving recess 40 in the lower part will have the lifting drive assembly, the driving mechanism, and the energy storage system located above the container-receiving recess. A disadvantage of this arrangement is that the centre of mass of the load-handling device will be high, with a negative effect on the stability of the load handling device.

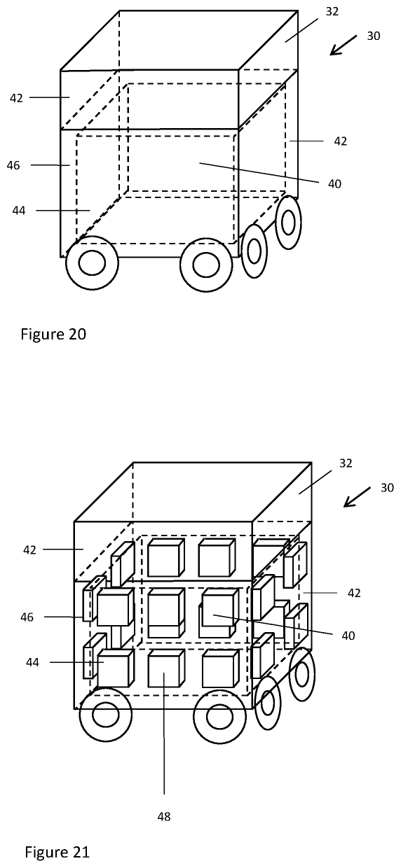

In order to lower the centre of mass and therefore improve stability of the load handling device, the one or more supercapacitor modules can be distributed around the outside of the container-receiving recess. FIG. 20 illustrates a load handling device 30, comprising a container-receiving recess 40 located within the vehicle body 32. The vehicle body 32 comprises four outer walls 42 at the four sides of the load handling device 30, and four inner walls 44 which form the inner surface of the vehicle body, in which the container-receiving recess 40 is located. There is a gap 46 between the inner walls 44 and the outer walls 42 of the vehicle body.

FIG. 21 illustrates how the supercapacitor modules 48 can be arranged within the gap 46 between the inner walls 44 and the outer walls 42. It will be appreciated that the centre of mass of the load handling device will be lowered, since the supercapacitor modules 48 are positioned lower in the load handling device. Without this arrangement, the assembly of one or more supercapacitor modules would otherwise be positioned in the upper part of the load handling device, above the container-receiving recess 40. The lower centre of mass results in a more stable load-handling device.

Stability of the load-handling device is an important consideration. An unstable load handling device could be at risk of falling over, which would necessitate grid downtime in order to retrieve the load-handling device and return it to an upright position.

Recalibrating Battery State of Charge Calculations with Periods of Low Current Drain

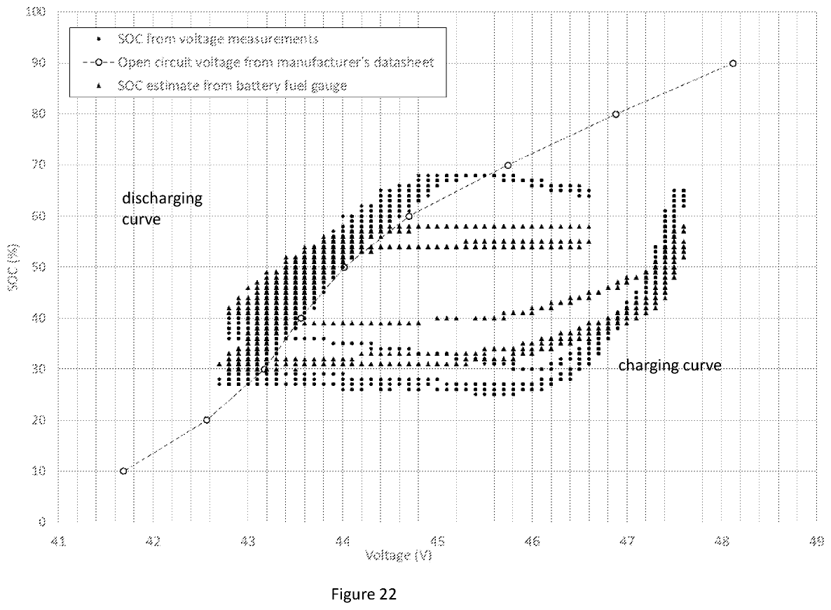

FIG. 22 shows a charge-discharge profile of a lithium-ion battery in a load handling device, plotting battery state of charge (SOC) against battery voltage. The data was measured after one day of operation of the load handling device on the grid. Three sets of data are plotted: i) SOC obtained from measuring the battery voltage at a range of different battery current values ii) open circuit voltage curve from the battery manufacturer's data sheet iii) SOC estimate from the battery fuel gauge at a range of different battery current values. Since i) and iii) are measured at a range of different current values, there are several sets of data rather than a single line. The data points for ii) are at a single current (open circuit voltage corresponds to zero current), so there is a single line of data. It can be seen from FIG. 22 that the three data sets all align; the subset of data points for both i) SOC obtained from measuring the voltage and iii) SOC estimate from the battery fuel gauge that align with the manufacturer's data are the measurements at zero current. This alignment indicates that the battery fuel gauge is accurately measuring the true SOC of the battery.

The battery fuel gauge SOC estimate is based on the coulomb counting method. This method measures the current drawn from and supplied to the battery and integrates it over time to estimate the available charge remaining. Coulomb counting is advantageous in that it is a simple method and straightforward to implement, but since no measurement of current can be perfectly accurate, the method can suffer from drift over time if the measurement is not recalibrated to a reference point.

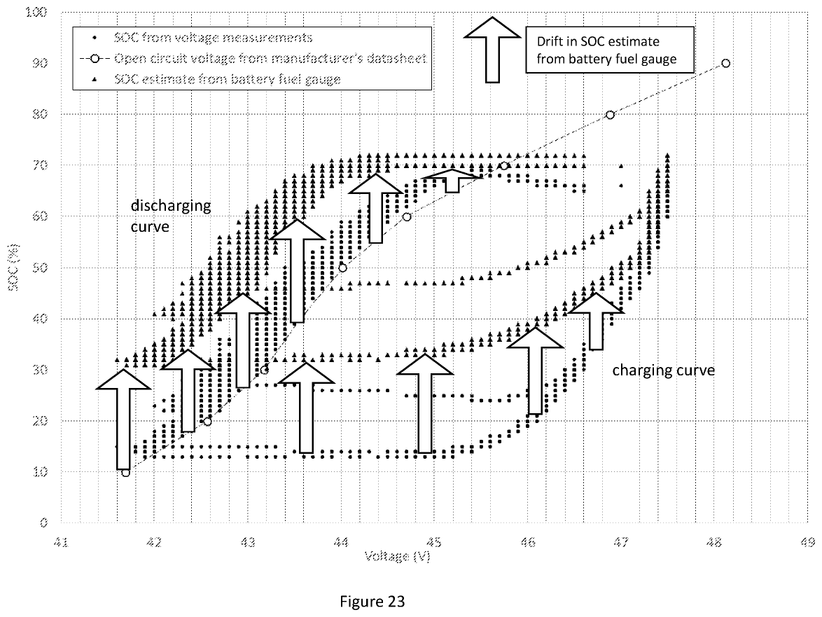

FIG. 23 shows a charge-discharge profile of a lithium-ion battery in a load handling device, plotting SOC against battery voltage, in a similar manner to FIG. 23. The data was measured after several days of continuous operation of the load handling device on the grid. Again, three sets of data are plotted: i) SOC obtained from measuring the battery voltage at a range of different battery current values ii) open circuit voltage curve from the battery manufacturer's data sheet iii) SOC estimate from the battery fuel gauge at a range of different current values. It can be seen from FIG. 23 that the SOC obtained from measuring the voltage is still aligned with the manufacturer's data along the charge profile curve. However, this is not the case for the SOC estimate from the battery fuel gauge, which is not aligned with the manufacturer's data. There is a gap between the battery fuel gauge reading of SOC and the actual SOC, represented by arrows in FIG. 23. This gap is up to 15-20% SOC in magnitude, and indicates that the battery fuel gauge is no longer accurately reporting the true SOC of the battery, but is in fact significantly overestimating the available SOC. This is the case for both the charging curve and the discharging curve.

This inaccuracy of the SOC estimate by the battery fuel gauge is a problem because the SOC is used by the control system to decide when to recharge the battery. For example, the control system may require the load handling device to travel to a charge station when the SOC has dropped below 30%. When the battery fuel gauge indicates that the SOC has dropped to 30%, the true SOC may be as low as 10-15%. This is a problem because it increases the risk of the load handling device's battery running out of charge before it can reach a charging station. In this situation, it may be necessary to stop the operation of the grid while the load handling device is retrieved and brought to a charging station.

This inaccuracy of the SOC estimate by the battery fuel gauge increases gradually with operation time; after one day's operation on the grid the battery fuel gauge is reporting SOC accurately (see FIG. 22), but after several days' continuous operation on the grid, the battery fuel gauge is not reporting SOC accurately.

The issue here is that the battery current tends to be underestimated because of inaccuracies in tracking transient peaks in the current. If the current transients occur at a higher frequency than the frequency at which the battery fuel gauge measures the current, the peaks will not be accurately captured. Underestimating the current supplied by the battery can lead to overestimation of the available charge remaining in the battery, which explains why the SOC estimate from the battery fuel gauge drifts upwards over time. Underestimating the current supplied by the battery, even by a small amount, will compound over time and result in drift between the battery fuel gauge SOC estimate and the actual SOC.

This problem can be solved by recalibrating the battery fuel gauge by allowing the battery cells to experience a period of low current drain, where zero current or as little current as possible, is drained from the battery. The rest periods give the battery fuel gauge the opportunity to recalibrate the SOC estimate and will tend to reduce the “drift”.

Recalibrating can be done by checking whether the SOC estimate from the battery fuel gauge at a known voltage and current is in line with an expected SOC from the manufacturer's data sheet at the same voltage and current. This can be any known current, but zero current is convenient because open circuit voltage curves are readily available from battery manufacturers. When the battery current is zero, for a given voltage the expected SOC can be read from the manufacturer's OCV curve. The battery fuel gauge can therefore identify that the expected SOC is different to the battery fuel gauge's SOC estimate, and recalibrate by updating the battery fuel gauge SOC estimate to match the expected SOC.

An alternative method of estimating SOC is voltage measurement rather than coulomb counting. But since the battery voltage drops steeply with time as the battery discharges, a small change in voltage corresponds to a large change in SOC. This means that voltage-based SOC estimation is not always accurate. Coulomb counting can be a better method of estimating SOC than measuring voltage, assuming that the calibration issue can be dealt with.

A load handling device with an energy storage system including an assembly of one or more supercapacitor modules as well as a battery may take advantage of the dual power sources by using the supercapacitor exclusively for a short period. This allows the battery to have a period of low current drain with zero or low current demand, during which the battery fuel gauge can recalibrate and therefore show a more accurate measurement of SOC.

While zero current draw is ideal for periods of low current drain in order to recalibrate the battery fuel gauge to the manufacturer's open circuit voltage curve, in practice zero current draw may not be achievable, and so the current draw should be kept as low as possible. Periods of low current drain can be achieved by the controller periodically disconnecting the battery from the assembly of one of more supercapacitor modules, such that no charge is supplied to the supercapacitor. “Periodically disconnecting” means disconnecting for a short time once every predetermined time period (for example, disconnecting once every four hours).

### Battery SOC Balancing

The individual cells in a battery pack naturally have somewhat different capacities, and so, over the course of charge and discharge cycles, may be at a different state of charge. Variations in capacity can be due to manufacturing variances, assembly variances (e.g., cells from one production run mixed with others), cell aging, impurities, or environmental exposure (e.g., some cells may be subject to additional heat from nearby sources like motors, electronics, etc.), and can be exacerbated by the cumulative effect of parasitic loads, such as the cell monitoring circuitry often found in a battery management system.

A battery may comprise a plurality of battery cells connected in series. In this case, it is necessary to “balance” the battery by maintaining the same voltage/SOC in each cell, as far as possible. Balancing an assembly of battery cells helps to maximise energy capacity and improve the battery service life.

A battery management system is used to monitor the condition of the battery pack, including properties of individual cells such as temperature and voltage. When charging, the entire battery pack can only be charged until one cell reaches its maximum safe charging voltage, even though other battery cells may still have capacity to be charged further. Therefore the battery cell with the lowest voltage limits the charge voltage of the entire battery pack. Similarly, the battery pack can only be safely discharged until one cell is fully discharged, even though other battery cells may still have usable charge. Therefore the battery cell with the lowest charge capacity limits the charge capacity of the entire battery pack. Failure to stop charging/discharging when one cell has reached its limit may permanently damage the battery cells. Lithium ion batteries are particularly susceptible to chemical damage by voltages or currents that are too high.

Battery balancing redistributes energy from the battery cells with higher energy capacity to the battery cells with lower energy capacity. Battery balancing can be passive balancing, in which energy is drawn from the most charged cell and dissipated as heat, or active balancing, in which energy is drawn from the most charged cells and transferred to the least charged cells. Active battery balancing can be performed by DC-DC converters.

A load handling device with an energy storage system including an assembly of one or more supercapacitor modules as well as a battery may take advantage of the dual power sources by using the supercapacitor to fulfil the acceleration demands of the load handling device, while drawing a constant low current from the battery, below a predetermined threshold current. A constant low current draw below the predetermined threshold current provides the optimum conditions for battery cell balancing. The optimum predetermined threshold current will depend on the size and specification of the battery, and can be determined by the battery manufacturer. For example, the predetermined threshold current may be a current of less than 3 amps.

### Opportunity Charging of Supercapacitor at Grid Locations Above Access Points

To fulfil customer orders, the load handling devices may retrieve a storage container and transport it to a grid location above an access point on the storage grid. The storage container is then lowered down a chute to the access point, where the storage container can then be accessed in order to fulfil an order. An operative can take an item out of the storage container at the access point and pack it as part of a customer's order. The load handling device can then raise the storage container back up through the grid and into the container receiving space, and then replace the storage container in the appropriate position within the storage grid.

The grid locations above access points on the storage grid are ideal locations for charging the assembly of one or more supercapacitor modules, since the load handling devices need to go to those locations frequently in order to bring storage containers to the access points. The storage system can therefore comprise one or more supercapacitor charge stations located at a grid location above an access point.

Advantageously, the supercapacitor charge stations can be high-rate inductive supercapacitor charge stations, so that the charging of the supercapacitor during lifting and lowering operations can be done by high-rate inductive charging. This enables the supercapacitor to be fully charged in a short time (order of seconds). Since supercapacitor charging is very fast, charging can be completed within the time that the load handling device spends at the grid location while lowering and raising the storage container. The load handling devices will make frequent visits to the grid locations above the access points, so these visits may be adequate for all the supercapacitor charging requirements. There will be no need for the load handling devices to undertake separate visits to other charging stations in order to charge the assembly of one or more supercapacitor modules. Supercapacitor charging can therefore be done during the normal operation of the load handling devices and no extra time is required.

After the supercapacitor has been charged at a grid location above an access point on the storage grid during a lifting or lowering operation, the supercapacitor can then be used to charge the rechargeable power source. This can be achieved by the controller on the load handling device instructing the assembly of one or more supercapacitor modules to charge the rechargeable power source. Alternatively, if the load handling device is about to go to a grid location for a lifting or lowering operation, the supercapacitor can be used to charge the rechargeable power source in advance, so that the supercapacitor is partially discharged and ready for charging by the supercapacitor charging station.

The supercapacitor can be used to charge the rechargeable power source at a low current. As described above, if the rechargeable power source is a battery, subjecting the battery to a low constant current of less than a predetermined threshold current is useful for balancing the battery cells to ensure a uniform state of charge across the different cells, which can extend the life of the battery. The current may be limited in order to allow battery balancing. The controller can instruct the supercapacitor to charge the rechargeable power source at a current below the predetermined threshold current.

If the supercapacitor is charged frequently enough and at a high enough charging rate, it may be possible for the rechargeable power source to be solely charged from the supercapacitor. This would remove the requirement for separate charging stations on the storage grid to charge the rechargeable power source. This would remove the requirement for the load handling device to travel to a rechargeable power source charging station on the storage grid and spend time there while the rechargeable power source is being charged. The need for downtime for charging the load handling device would be effectively eliminated, allowing the load handling device to operate continuously on the storage grid.

As described above, the load handling device may be controlled by a control system monitoring the charge level of the rechargeable power source, and instructing the load handling device to go to a charge station if this charge level falls below a predetermined threshold charge level. In this embodiment of the invention where the load handling device can operate continuously on the storage grid without needing to visit rechargeable power source charge stations, the supercapacitor charge stations enable the load handling device to maintain the rechargeable power source voltage level above a predetermined threshold voltage for powering the electrical loads.

In a situation where the load handling device is operating continuously on the storage grid, recalibration of the battery state of charge estimate, as described above, is particularly important.

### Battery/Supercapacitor Technologies

It will be appreciated that the assembly of one or more supercapacitor modules may comprise, but is not limited to, capacitors, supercapacitors, ultracapacitors, lithium capacitors, electrochemical double layer capacitors, electric double layer capacitors, pseudocapacitors, hybrid capacitors, or some combination of these capacitor technologies.

It will be appreciated that the rechargeable power source may comprise, but is not limited to, lithium ion batteries, lithium-ion polymer batteries, lithium-air batteries, lithium-iron batteries, lithium-iron-phosphate batteries, lead-acid batteries, nickel-cadmium batteries, nickel-metal hydride batteries, nickel-zinc batteries, sodium-ion batteries, sodium-air batteries, thin film batteries, solid state batteries, or smart battery carbon foam-based lead acid batteries, or some combination of these technologies.

### Advantages of Using a Low-Pass Filter

A low-pass filter circuit is advantageous for reducing the number of transient current cycles in the rechargeable power source. High frequency transients in the current provided to the electrical load are “smoothed out” by the low-pass filter circuit, so the current passing through the rechargeable power source has high-frequency transient components removed. This protects the rechargeable power source from surges in current draw. Where the rechargeable power source is a battery, this is particularly advantageous because reducing transients in the current has been shown to reduce the aging effect on the battery.

The removal of the transients means that the rechargeable power source is not subject to any charge-discharge cycles, significantly extending its expected lifetime. Supercapacitors are well suited to handle transients in current, since they have a high power density and do not suffer from premature aging from large numbers of charge-discharge cycles.

The use of a low-pass filter also improves the rechargeable power source's efficiency. Power loss is proportional to the current squared, so a lower current results in a much reduced power loss.

As well as improving efficiency, reducing power losses is particularly important when the load-handling device is handling chilled or frozen goods and the fulfilment centre needs to be kept at a low temperature. Rejected heat from the rechargeable power source in the load handling device means that the fulfilment centre's cooling system needs to expend more energy to maintain the required low temperature.

### Circuit Diagram Featuring Low-Pass Filter

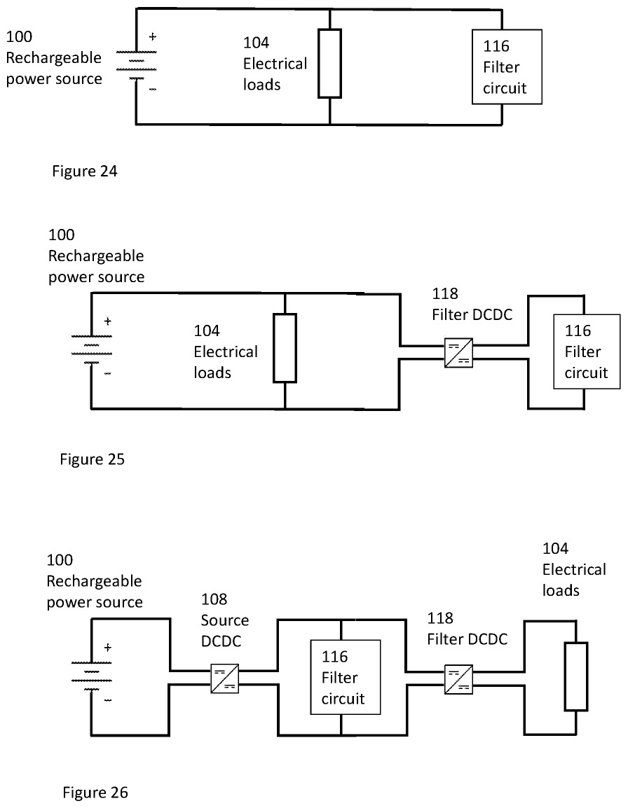

FIG. 24 is a circuit diagram showing a rechargeable power source 100 connected in parallel with an electrical load 104 and a filter circuit 116. The electrical load 104 may comprise one or more electric motors which enable movement of the vehicle in the X and Y directions respectively along the rails by driving sets of wheels 34 and 36, and/or one or more motors that drive a lifting device or crane mechanism to lift a storage container from above.

For ease of illustration the circuit diagram in FIG. 24 shows the rechargeable power source 100 as a single battery cell, and the electrical loads 104 as a single electrical load. It will be appreciated that the rechargeable power source of the load handling device is not limited to a battery, and a battery may comprise an assembly of one or more battery cells rather than a single battery cell, and that the electrical loads may comprise a number of electric motors and other components rather than a single electrical load.

### DCDC Converters

The circuit may additionally comprise one or more DCDC converters. As shown in FIG. 25, the circuit may additionally comprise a filter DCDC converter 118 between the electrical loads 104 and the filter circuit 116. The purpose of the filter DCDC converter 118 is to convert the voltage across the rechargeable power source to a different voltage across the filter circuit. With one filter DCDC converter 118 for the filter circuit 116, the voltage across the rechargeable power source and the load voltage may be the same.

The filter DCDC converter 118 between the between the electrical loads 104 and the filter circuit 116 may comprise a boost converter or a buck converter. A buck converter is particularly advantageous if the filter circuit comprises one or more supercapacitors in parallel with the electrical loads 104, since the voltage across the one or more supercapacitors will be lower. A reduced voltage means that a lower-rated supercapacitor, or fewer supercapacitor modules in parallel, will be required.

The circuit may additionally comprise a source DCDC converter 108 between the rechargeable power source 100 and the filter circuit 116, as shown in FIG. 26. The purpose of the source DCDC converter 108 is to convert the voltage across the rechargeable power source 100 to a different voltage across the filter circuit 116. It will be appreciated that with two DCDC converters 108 and 116, the rechargeable power source 100 and the electrical loads 104 may be at the same voltage or at different voltages.

The source DCDC converter 108 between the rechargeable power source 100 and the filter circuit 116 may comprise a boost converter or a buck converter.

### Low-Pass Filter

A low-pass filter has a cut-off frequency; and signals with a frequency lower than this cut-off frequency are permitted to pass through the filter, and signals with frequencies higher than the cut-off frequency are attenuated. The filter attenuates high frequencies in the input signal, but the signal experiences little attenuation below the cut-off frequency.

An ideal low-pass filter would permit frequencies below the cut-off frequency to pass through the filter unchanged, while completely eliminating all frequencies above the cut-off frequency. The frequency response is a step function. In practice an electronic low-pass filter is not an ideal filter, and the exact frequency response of the filter depends on the filter design.

Active Vs. Passive Filters

Filter circuits can either be active or passive. Active filters require an additional power supply, and include amplifying devices to increase the signal strength. The gain is greater than unity, increasing the power available in a signal compared to the input. Passive filters do not contain amplifying devices to strengthen the signal, and require no additional power supply. Passive filters cannot have a net power gain, and dissipate energy from a signal such that the gain is less than unity and the output signal has a smaller amplitude than its corresponding input signal.

Passive filter circuits can be built from components such as resistors, inductors, and capacitors. Not requiring an additional power supply is an advantage, because it makes the circuit less complex.

Active filters have the advantage that they can realize a given transfer function at some frequency ranges without using inductors, which are relatively large and costly components compared to resistors and capacitors. Since inductors are not used, active filters can be made in a very compact size and do not produce or interact with magnetic fields that may be present.

### Multiple Stage Filter

Multiple stage filters can be constructed, by “cascading” filter circuits together. Higher-order filters have a greater rate of attenuation for signals as the frequency increases above the cut-off frequency. As the order of the filter is increased, the filter approaches the characteristics and behaviour of an ideal filter.

Multiple-stage active filters have the advantage of good isolation between the stages, so their characteristics are independent of the source and load impedances. In contrast, multiple-stage passive filters are more difficult to design because each stage must take into account the frequency-dependent loading of the preceding stage.

### Filter Circuit Examples

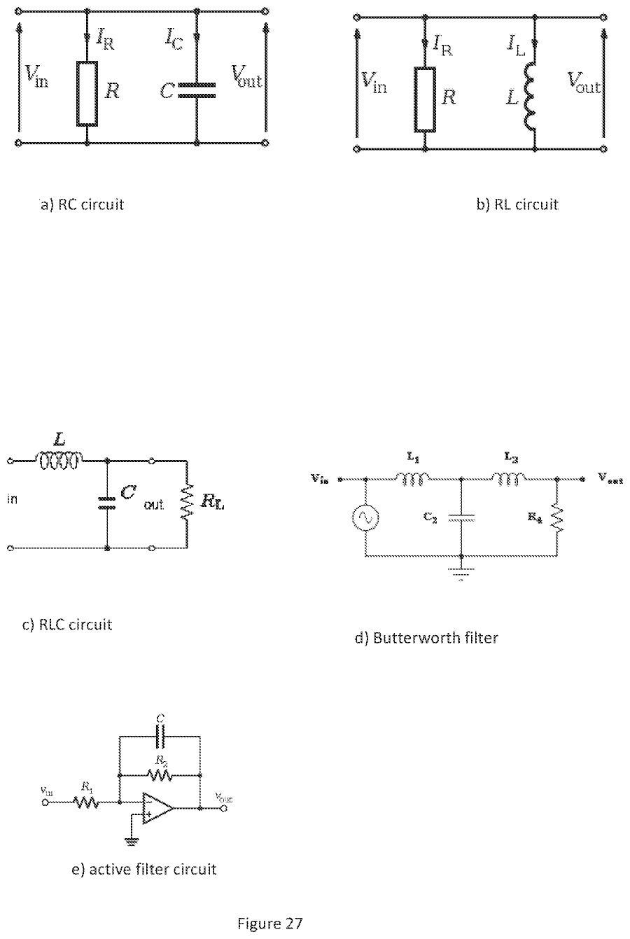

One method of filtering a signal is an RC filter, which is a circuit comprising one or more resistors and one or more capacitors driven by a voltage or current source. The circuit is named “RC” because R and C are the usual symbols used for resistance and capacitance respectively. A first order RC circuit is the simplest kind of RC circuit, and comprises one resistor and one capacitor. An RC circuit for filtering a current signal comprises a resistor and a capacitor in parallel driven by a current source. The cut-off frequency is determined by the RC time constant of the circuit. FIG. 27a illustrates a parallel RC circuit. A first order RC filter can be built using a supercapacitor in parallel with the rechargeable power source 100 and with the electrical loads 104.

An alternative method of filtering a signal is an RL filter, which is a circuit comprising one or more resistors and one or more inductors driven by a voltage or current source. The circuit is named “RL” because R and L are the usual symbols used for resistance and inductance respectively. A first order RL circuit is the simplest kind of RL circuit, and comprises one resistor and one inductor. An RL circuit for filtering a current signal comprises a resistor and an inductor in parallel driven by a current source. FIG. 27b illustrates a parallel RL circuit.

Another alternative is an RLC filter, which is an electric circuit comprising one or more resistors, one or more inductors, and one or more capacitors. A second-order RLC circuit is the simplest kind of RLC circuit, comprising one resistor, one inductor, and one capacitor, connected in series or in parallel. The circuit is named “RLC” because R, L, and C are the usual symbols used for resistance, inductance and capacitance respectively. Among other applications, an RLC circuit can be used as a low-pass filter. The RLC filter is described as a second-order filter because the voltage or current in the circuit can be described by a second-order differential equation. FIG. 27c illustrates a simple RLC circuit.

Higher order passive RLC filters can also be used, for example a Butterworth filter (FIG. 27d).

The above circuits are all passive filters. An active low-pass filter circuit can be built, for example by using operational amplifiers. FIG. 27e illustrates an active filter circuit with an operational amplifier.

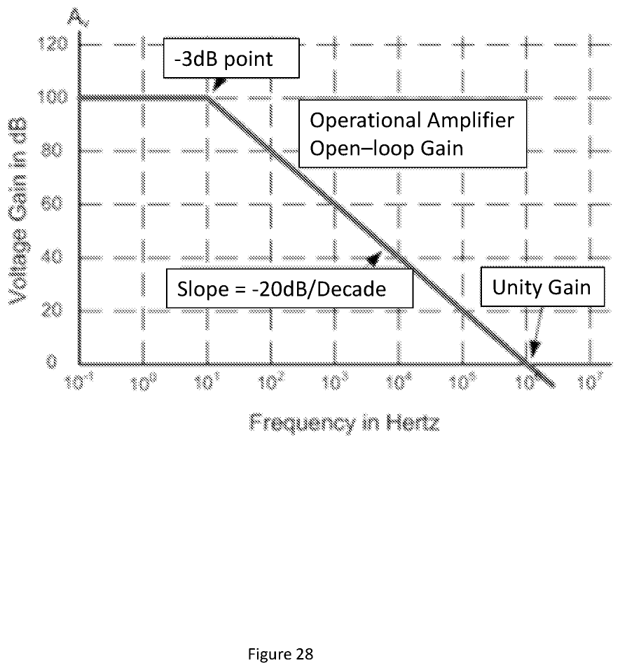

Operational amplifiers are characterized by the gain-bandwidth product (GBWP), is the product of the amplifier's bandwidth and the gain at which the bandwidth is measured. The gain-bandwidth product is nearly independent of the gain at which it is measured, so to a first approximation the gain is inversely proportional to frequency. For example, FIG. 28 illustrates an operational amplifier with a GBWP of 1 MHz. The operational amplifier would have a gain of 1 (0 dB) at a frequency of 1 MHz, and a gain of 10 (20 dB) at a frequency of 100 kHz, and a gain of 1000 (60 dB) at a frequency of 1 kHz. The DC gain for this example is 100 000, or 100 dB. This inverse proportionality response coupled with the high DC gain gives the operational amplifier the characteristics of a first order low-pass filter. The cut-off frequency is given by the GBWP divided by the DC gain. For the operational amplifier illustrated in FIG. 27e, the GBWP is 1 MHz, the DC gain is 100 000, so the cut-off frequency is 10 Hz. Signals at a frequency of 10 Hz or below are allowed to pass with maximum gain, and higher frequency signals are subject to a lower gain.

### Transient Currents During Lifting/Lowering Operations

FIG. 19 showed the transient nature of the current during a lowering and lifting operation of a load handling device on the storage grid.

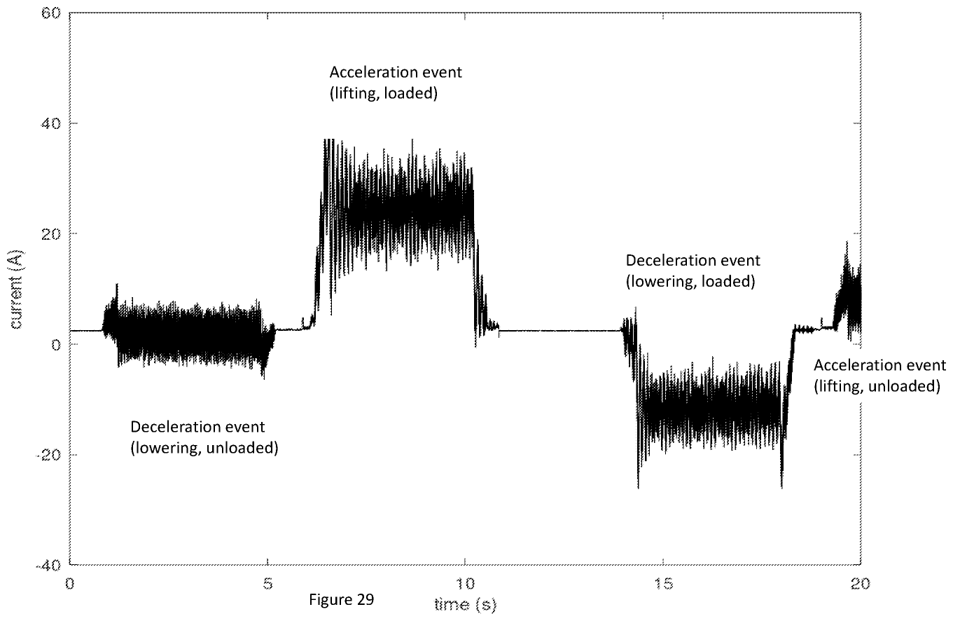

FIG. 29 illustrates another example of a hoist operation of the load handling device. First the grabber device 39 is lowered into the storage grid (a deceleration event) to a depth of 21 grid positions. The grabber device then grips a storage container 10 with mass 30 kg, and lifts the storage container up to the top of the grid and into the container receiving space within the load handling device (an acceleration event). The grabber device then lowers the storage container back down to its original position in the storage grid (a second deceleration event), releases the storage container, then lifts the grabber device back up to the top of the grid (a second acceleration event). It can be seen from FIG. 29 that the first acceleration event, where the grabber device is lifted while loaded with a 30 kg storage container, has a much higher average current than the second acceleration event, where the grabber device is lifted while not carrying a load. Similarly the second deceleration event, where the grabber device is lowered while loaded with a 30 kg storage container, has a much higher average current than the first deceleration event, where the gripper device is lowered while not carrying a load.

Table 5 below lists the average current of each of the four acceleration/deceleration events illustrated in FIG. 29, along with the peak-to-peak variation in current for that event. It can be seen that the variation is significant, with a peak-to-peak variation of more than 40 amps for the first acceleration event.

TABLE 5
Average and peak-to-peak variation in
current during lifting/lowering operation

| | Average | Peak-to-peak |
|---|---|---|
| | current | variation in |
| Event description | (A) | current (A) |
| First deceleration event: Grabber | 1.92 | 12.24 |
| device lowered | | |
| First acceleration event: Grabber | 23.97 | 40.63 |
| device and storage container lifted | | |
| Second deceleration event: Grabber | 2.42 | 0.16 |
| device and storage container lowered | | |
| Second acceleration event: Grabber | −11.23 | 17.73 |
| device lifted | | |

### Fourier Transforms of Current Signal

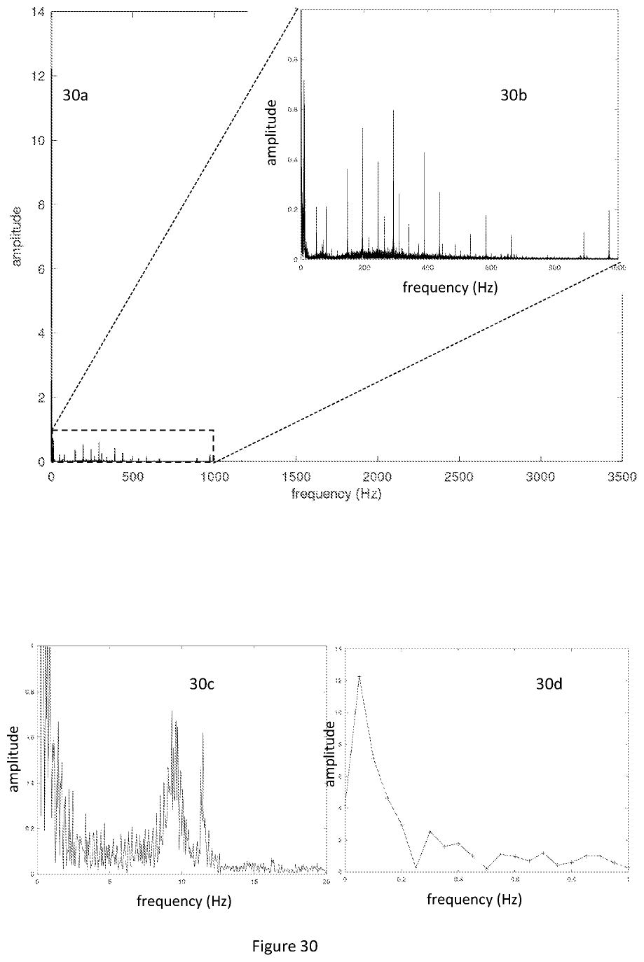

In order to get a better understanding of the high-frequency components of the current signal, FIGS. 30a-d plot the Fourier transform of the current signal plotted in FIG. 29. The sampling frequency was 6250 Hz, so the Fourier plots use a scale from zero up to the Nyquist frequency of 3125 Hz. FIG. 30a plots the entire Fourier transform, which shows a large spike at low frequency and a number of smaller spikes in the frequency range up to 1000 Hz. FIG. 30b (inset) plots the same Fourier transform over the range 0-1000 Hz and amplitude up to 1, from which it can be seen that the majority of the smaller spikes occur at frequencies above 20 Hz. FIG. 30c plots the same Fourier transform over the range 0-20 Hz and amplitude up to 1. It can be seen that the low-frequency peak is below 1 Hz, and there is a large peak at around 9 Hz and a second at around 11 Hz. FIG. 30d plots the Fourier transform in the range 0-1 Hz; though it is difficult to see the detailed shape of the spectrum at this resolution, a peak at around 0.08 Hz is visible. 0.08 Hz corresponds to a period of around 12.5 seconds, which is the period for one lifting and lowering operation (it can be seen from FIG. 29 that the time between the start of the first deceleration event and the second deceleration event is arounds 12.5 seconds, and the time between the start of the first acceleration event and the second acceleration event is arounds 12.5 seconds).

From inspecting the Fourier transform of the current signal, it can be seen that most of the noise in the current is between 20 Hz and 1000 Hz, with additional spikes at 9 Hz and 11 Hz. A low-pass filter at 20 Hz or at 7 Hz would remove most of these transients and produce a smoother signal.

The above example demonstrates how the predetermined cut-off frequency can be determined from the Fourier transform of a signal. When the predetermined cut-off frequency is known, a filter circuit can be designed to act as a low-pass filter, and to pass frequencies below the predetermined cut-off frequency and to attenuate frequencies above the predetermined cut-off frequency.

For a passive low-pass filter circuit, the specifications of the components can be chosen such that the circuit frequency is equal to the predetermined cut-off frequency. For example, in an RC filter circuit the values of resistance and capacitance can be chosen such that the circuit frequency is the desired cut-off frequency. In an RL filter circuit the values of resistance and inductance can be chosen such that the circuit frequency is the predetermined cut-off frequency. In an RLC filter circuit the values of resistance, inductance, and capacitance can be chosen such that the circuit frequency is the predetermined cut-off frequency.

For an active low-pass filter circuit using an operational amplifier, the characteristics of the operational amplifier can be chosen such that the circuit's cut-off frequency is the same as the predetermined cut-off frequency. As described above in reference to FIG. 28, to first approximation the cut-off frequency of an operational amplifier can be calculated by dividing its GBWP by its DC gain.

### Low-Pass Filter RC Circuit

The principle of designing a low-pass filter circuit with a predetermined cut-off frequency will be illustrated here with reference to a first order RC filter. It will be appreciated that this specific circuit is one of many possible implementations of filter design, and is not intended to be limiting.

FIG. 27a is a diagram illustrating a simple first-order RC filter circuit, with a resistor and capacitor connected in parallel. The time constant of the filter is calculated from the product of the resistance and capacitance, so the cut-off frequency f is given by Equation 1 below:

f=½πRC Equation 1

where R is the resistance and C is the capacitance of the circuit.

The reactance X is given by Equation 2. At higher frequencies the reactance drops, and the capacitor effectively functions as a short circuit.

X=−½πfC Equation 2

Low-frequency components of the current signal are attenuated by the reactance of the capacitor; instead of current passing freely through the capacitor, charge builds up on the capacitor plates. A pure DC current (zero frequency component of the current signal) would not be able to pass through the capacitor at all, so must go through the resistor instead. Low frequency components would not be entirely blocked by the capacitor, but their amplitude is attenuated and at least part of the current is directed through the resistor.

High-frequency components of the current signal flow very well through the capacitor, since there is little time for the capacitor to build up charge before the direction of the high-frequency component of the current changes. The current effectively short-circuits through the capacitor, in preference to flowing through the resistor.

In practice the capacitor behaves between these two extremes, because the current signal comprises components at a range of frequencies.

For the current signal discussed above and illustrated in FIG. 29, inspecting the Fourier transform of the current signal (illustrated in FIG. 30) suggests that a predetermined cut-off frequency of around 20 Hz, or (preferably) 7 Hz would be suitable. Equation 1 can be used to select appropriate values of R and C in order to create a filter circuit with a circuit frequency of 20 Hz or 7 Hz.

Equation 1 can be rearranged to calculate the required capacitance (Equation 3):

C=½πRf Equation 3

Using a resistor with a resistance of 3.5 mΩ, applying Equation 3 gives a desired capacitance of 2.3 F for the 20 Hz circuit, and 6.6 F for the 7 Hz circuit.

### Demonstration of Low-Pass Filtering Through Simulation

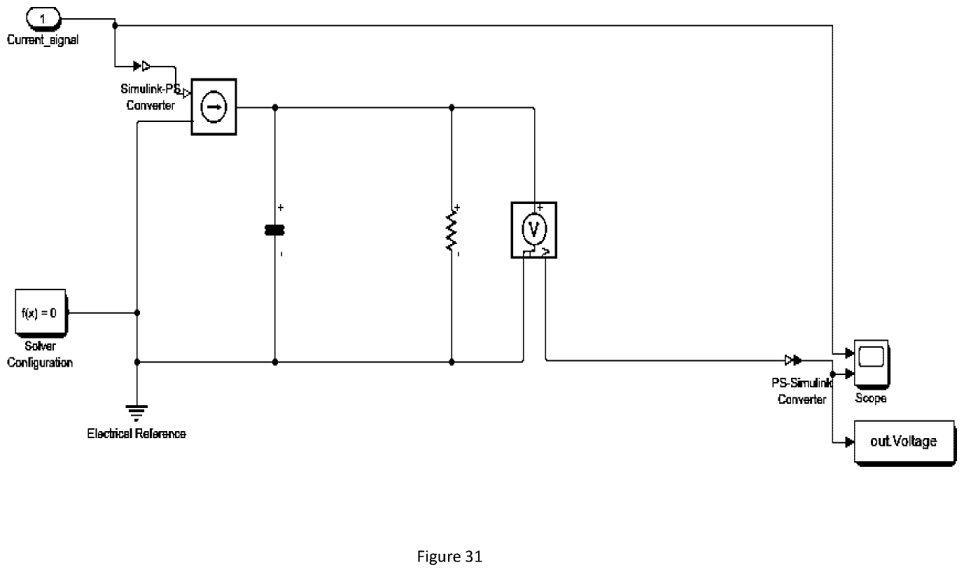

FIG. 31 is a Simulink model of a simple RC filter circuit, with a resistor and capacitor in parallel. A 48V voltage source represents the rechargeable power source, and a resistor represents the electrical loads. The resistance of the resistor is 3.5 mΩ. The current signal from FIG. 29 is applied through the resistor, and the current signal at the rechargeable power source is plotted.

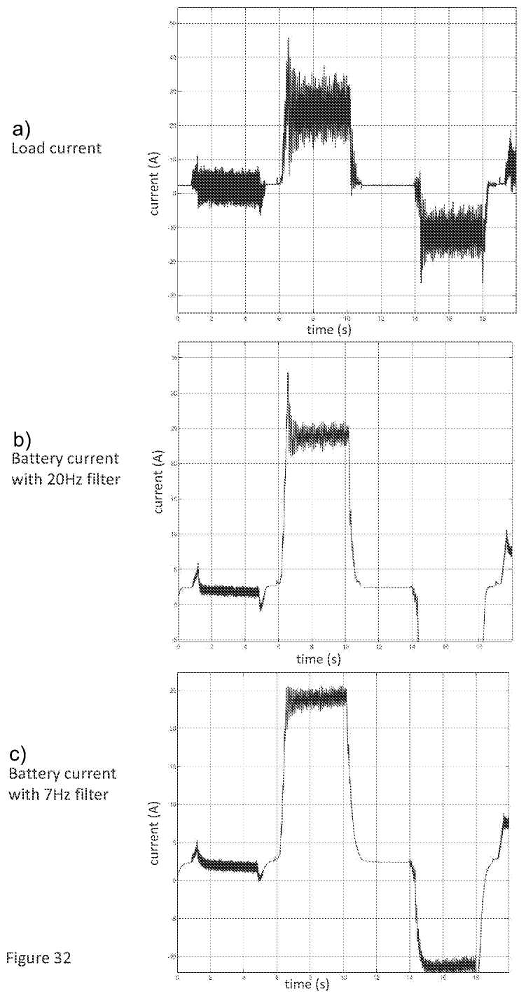

FIG. 32 plots the current signal through the resistor and through the rechargeable power source. As calculated above, a filter circuit with a circuit frequency of 20 Hz should filter out most of the transients from the current signal. FIG. 32a is the original current signal, the same as in FIG. 29. FIG. 32b is the filtered signal at the rechargeable power source, using an RC filter circuit where the circuit frequency is 20 Hz, the resistor has a resistance of 3.5 mΩ, and the capacitor has a capacitance of 2.3 Farad. It can be seen that the transients in the current through the rechargeable power source have been significantly reduced compared to the input current. The input current has a spike of 47 amps at around 6.5 seconds, at the beginning of the first acceleration event, which is reduced to a significantly lower spike of 33 amps seen by the rechargeable power source. This demonstrates that the use of a capacitor in a filter circuit will reduce transients and spikes in the current, and therefore reduce the aging effect on the rechargeable power source.

As calculated above, the filter circuit at 7 Hz should filter out transients from the current signal as with the 20 Hz circuit, and also filter out the peaks observed at 9 Hz and 11 Hz. FIG. 32c is the filtered signal at the rechargeable power source, using an RC filter circuit where the circuit frequency is 7 Hz, the resistor has a resistance of 3.5 mΩ, and the capacitor has a capacitance of 6.6 Farad. It can be seen that the transients in the current through the rechargeable power source have been significantly reduced compared to the input current, even more so with the filter circuit frequency at 7 Hz than with the filter circuit frequency at 20 Hz. The input current spike of 47 amps at around 6.5 seconds, at the beginning of the first acceleration event, is reduced to 26 amps seen by the rechargeable power source. This spike is small compared to the average current of 24 amps for the first acceleration event.

Table 6 below lists the average current of each of the four acceleration/deceleration events, the peak-to-peak variation in current for that event, and the peak-to-peak variation in current after filtering at 20 Hz and at 7 Hz. It can be seen that the peak-to-peak variation is much reduced by the filtering.

TABLE 6
Average and peak-to-peak variation in current during lifting/
lowering operation, after filtering at 20 Hz and 7 Hz

| | | Peak- | Peak- | Peak- |
|---|---|---|---|---|
| | | to-peak | to-peak | to-peak |
| | | variation | variation in | variation in |
| | Average | in | current (A) | current (A) |
| | current | unfiltered | filtered at | filtered at |
| Event description | (A) | current (A) | 20 Hz | 7 Hz |
| First deceleration event: | 1.92 | 12.24 | 1.93 | 1.87 |
| Grabber device lowered | | | | |
| First acceleration event: | 23.97 | 40.63 | 12.14 | 5.89 |
| Grabber device and | | | | |
| storage container lifted | | | | |
| Second deceleration | 2.42 | 0.16 | 0.13 | 0.15 |
| event: Grabber device | | | | |
| and storage container | | | | |
| lowered | | | | |
| Second acceleration | −11.23 | 17.73 | 3.58 | 2.74 |
| event: Grabber device | | | | |
| lifted | | | | |

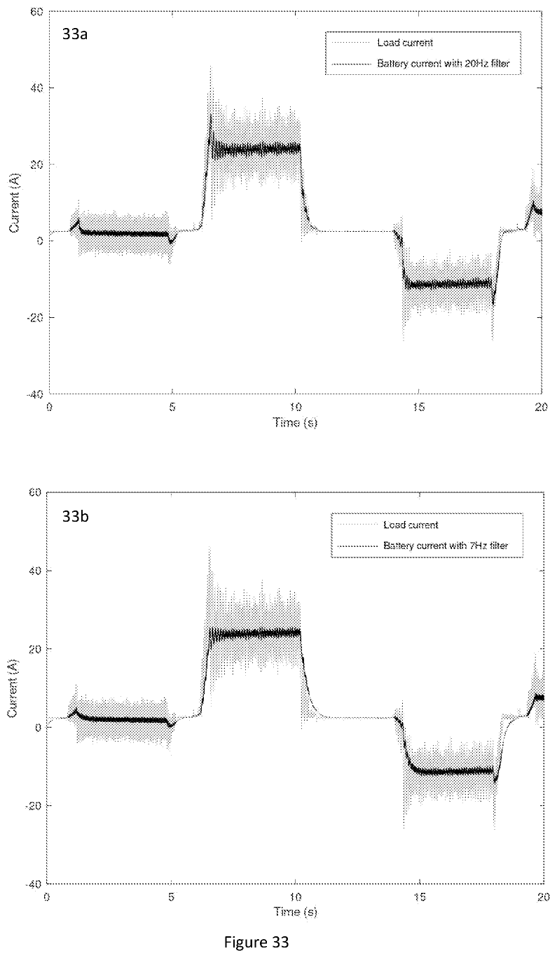

FIG. 33a compares the load current with the current through the rechargeable power source with a 20 Hz filter circuit, and FIG. 33b compares the load current with the current through the rechargeable power source with a 7 Hz filter circuit. It is easy to see from the figure how the transients in the current signal have been attenuated significantly.

### Lithium Ion Battery Cell Nonlinearity

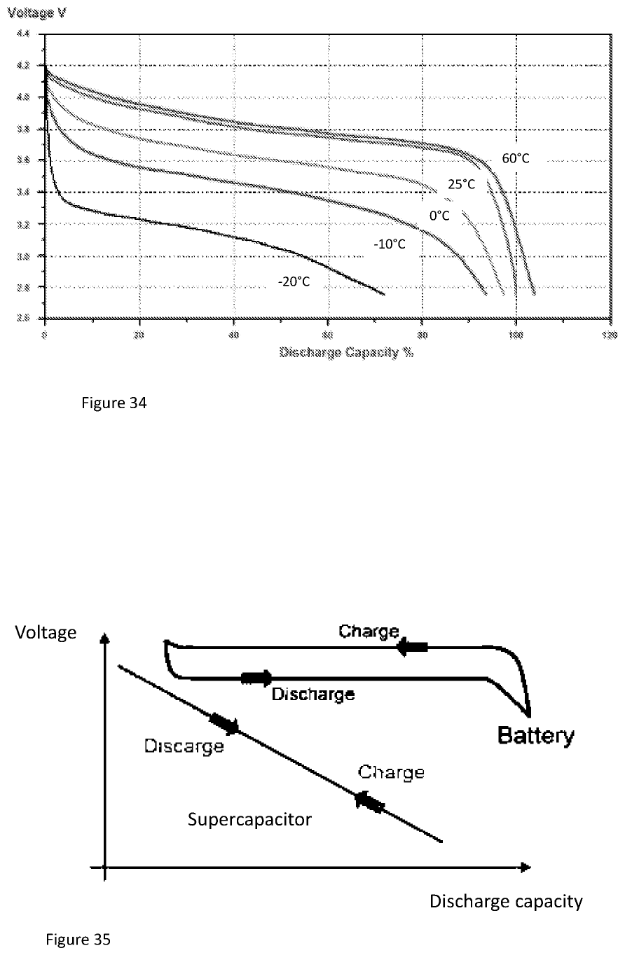

FIG. 34 shows a typical discharge curve for a lithium-ion battery cell, which plots the cell voltage against the discharge capacity. Discharge capacity is defined as 100% minus the state of charge: a state of charge of 100% corresponds to a discharge capacity of 0%, and a state of charge of 0% corresponds to a discharge capacity of 100%. It can be seen that the discharge curve is highly non-linear. This means that in practice the lithium-ion cell does not operate across the whole of its voltage range. Although the voltage range can go up to 4.2V in a single lithium-ion battery cell, in practice the highly non-linear shape of the curve means that the battery cell spends most of its time between 3 and 4 volts. The figure shows an indicative voltage curve only; in practice the shape of the curve depends on factors such as temperature and discharge rate. Other battery cell chemistries have a different maximum voltage and different discharge curve, but can also be non-linear. This can be a problem for a load handling device where the rechargeable power source is a battery, because the load handling device is not able to use the full battery range.

To provide power to one or more load motors, several lithium-ion battery cells can be arranged in series. For example, 12 lithium-ion battery cells in series give a voltage range of up to 12*4.2=50.4V, sufficient to power one or more load motors at a nominal voltage of 48V. The lithium-ion cells will spend most of their time operating between 36V (12×3V) and 48V (12×4V). In practice a lithium-ion battery only uses a fraction of its full voltage range (and therefore only uses a fraction of its full energy storage).

However, in practice, once the voltage of the lithium-ion battery pack has dropped below a threshold voltage for powering the electrical loads, the load motors will not have sufficient power to provide the required acceleration for the load handling device. This can happen before the lithium-ion cells are fully discharged, meaning that only part of the useful range of the lithium-ion cells is used to provide power. Once the threshold voltage is reached, the battery will not be able to provide sufficient power, so the load handling device must be charged. For a load handling device with a 48V lithium-ion battery pack and with 48V electrical loads, this threshold voltage is around 42.6V.

In some embodiments, the load handling device may need to achieve a predetermined acceleration in order to carry out its function. In order to achieve the throughput of items from the storage system to fulfil orders and therefore meet demand, it is essential that the load handling devices operate at a maximum possible acceleration on the grid. The greater the acceleration of the load handling devices operable on the grid, the quicker the load handling devices can reach a desired grid cell when retrieving or storing a storage container from a given stack. Conversely, the lower the acceleration of the load handling device operating on the grid, the longer it will take the load handling device to reach a desired grid cell and thus, the more time consuming for the load handling device to retrieve a storage container from a given stack. As a result, to maintain the throughput of items from the storage system and thus meet demand with a lower acceleration, an increased number of load handling devices would need to be operational on the grid.

The storage system comprises a control system that manages the movements of the load handling devices on the grid. The control system keeps track of the positions of each of the load handling devices, instructs the load handling devices to move to new locations, and avoids collisions. If a load handling device is not able to achieve the required acceleration, it may not be able to fulfil the required movement in the predicted time. Other load handling devices may need to slow down or be re-routed in order to avoid a collision. As well as making the control much more complicated, this can slow down or interfere with the routes of other load handling devices on the grid, not just the load handling device with insufficient acceleration.

Therefore, in some embodiments it may be beneficial to define a predetermined acceleration for the load handling device to fulfil its function. This may be a linear acceleration of the load handling device moving along the tracks on the grid framework structure, or an acceleration of the grabber device lifting a container from the storage system up in to the container receiving space of the load handling device, or both. The predetermined acceleration defines the torque requirements for the lifting drive assembly and/or the driving mechanism, and therefore defines the torque requirements for the motors. The torque requirement defines a threshold voltage. This voltage will be referred to as the predetermined threshold voltage, since its value is defined by the predetermined acceleration. Typically, this is referred to as the operational voltage of the electrical load. When the motor voltage drops below this predetermined threshold voltage, the load handling device will not be able to achieve the predetermined acceleration. In an exemplary embodiment, for a load handling device with a 48V lithium-ion battery pack and with 48V electrical loads, this predetermined threshold voltage is around 42.6V.

The usable fraction of the battery's voltage range is therefore reduced even further. For example, a 5 kWh lithium-ion battery may only use the top ^{˜}1.5 kWh (top third) of its energy capacity. This is an issue because the cost and mass of batteries are significant, and only part of that battery capacity is available for use, so the battery must be charged more frequently than would otherwise be necessary. Charging requires downtime, as well as the time and energy spent by the load handling device in travelling to and from a charge station on the storage grid.

The problem to be solved is, how can the load handling device be made to operate for a longer time before needing to charge the rechargeable power source?

One way to increase the time between charges is to increase the voltage of the rechargeable power source. However, this is suboptimal because higher voltages require greater safety precautions to protect human operators. Higher voltages require higher-rated components, with higher associated costs. Also, increasing the voltage does not solve the problem that the rechargeable power source is only being operated within part of its useful range.

An alternative approach is to use a greater proportion of the rechargeable power source's operating voltage by using a second power source as a “booster” to enable the energy storage system to provide enough power once the voltage of the rechargeable power source has dropped below the predetermined threshold voltage for powering the electrical loads.

A supercapacitor could be placed in parallel with the rechargeable power source, such that both the supercapacitor and the rechargeable power source provide power to the load motors at the same voltage. However, this is not ideal because only a part of the supercapacitor's useful voltage range will be used. The cost of supercapacitors per unit energy storage is higher than for other rechargeable power sources, and several supercapacitor modules in series could be required to reach the required voltage.

FIG. 35 compares the typical discharge curves for a battery and a supercapacitor. The supercapacitor's discharge curve is approximately a straight line, with the voltage decreasing linearly with discharge capacity (discharge capacity is defined as 100%−state of charge). The battery discharge curve is much shallower, so for the same change in voltage the battery will experience a larger change in SOC. When a battery and supercapacitor are connected in parallel, they will be subjected to the same voltage. The difference in shape of the discharge curves means that when a battery and supercapacitor in parallel experience the same voltage drop, the battery state of charge will drop further than that of the supercapacitor, because the battery's discharge curve is shallower than that of the supercapacitor. The supercapacitor would therefore undergo a smaller change in state of charge, and only be using a small proportion of its SOC range. Therefore a circuit comprising a supercapacitor and battery connected in parallel, both supplying power to an electrical load, has the disadvantage that only part of the supercapacitor's full SOC range can be used.

Supercapacitor as Booster Connected in Series with the Rechargeable Power Source

Another way of using a supercapacitor as a power booster would be to connect a supercapacitor in series with a rechargeable power source. Since the supercapacitor's discharge curve is linear, its entire voltage range can be used.

Since supercapacitors have a low energy density and are more expensive per unit energy storage than for other rechargeable power sources, supercapacitors of a lower nominal voltage can be used. Connecting the assembly of one or more supercapacitors in series with the rechargeable power source means that the supercapacitor nominal voltage can be lower than that of the rechargeable power source—it is not necessary to connect several supercapacitor cells in series to match the rechargeable power source's voltage—therefore fewer supercapacitor cells can be used.

Connecting a supercapacitor in series with a rechargeable power source means that the load handling device can continue operating if the combined voltage across the supercapacitor and the rechargeable power source is greater than or equal to the predetermined threshold voltage for powering the electrical loads, even when the voltage across the rechargeable power source has dropped to below the predetermined threshold voltage. In practice this means that the load handling device can operate for a longer time between charges at a charging station.

In the example given above, for a nominal 48V lithium-ion battery pack with nominal 48V electrical loads, the predetermined threshold voltage is around 42.6V. With a battery alone, the load handling device would need to be charged once the battery voltage drops to 42.6V. However, with a 5V supercapacitor in series with the battery, the load handling device can continue operating until the battery voltage drops to 37.6V, when the combined voltage 5V+37.6V across the battery and supercapacitor has dropped to the predetermined threshold voltage of 42.6V.

Supercapacitors are readily available commercially with voltages of 2.7 or 5.4V. Other voltages are also available.

### Peak Power Demand is for a Short Time Only

As described above, the energy storage system of the load handling device must be able to provide sufficient power to the driving mechanism and/or the lifting drive assembly in order to complete an acceleration event. The acceleration events, however, do not have a constant power demand.

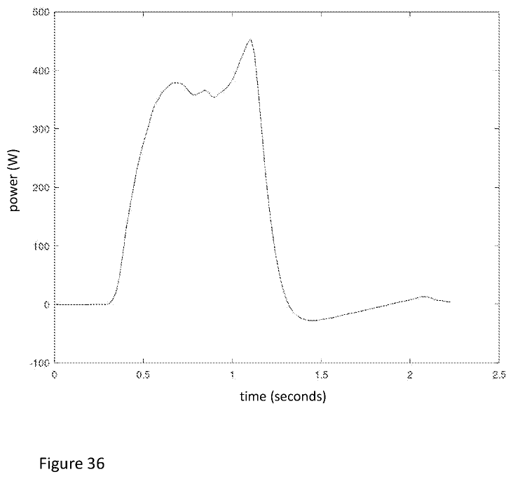

The peak demand from the electrical loads occurs for a short time only. FIG. 36 plots the power demand from a motor powering the wheels of the load-handling device, as the load-handling device moves on top of the storage grid. It can be seen that the peak power demand occurs at around 1.1 seconds, and lasts for only a fraction of a second. The energy storage system therefore needs to provide the maximum power for only a short time. A supercapacitor is perfectly suited to provide this power boost, since it has a high power density but a low energy density. Since the demand is for a short time, a high energy storage capacity is not required. The supercapacitor can assist in meeting the power demand without adding significant extra mass or cost to the energy storage system.

The deceleration event can also be seen on FIG. 36, between about 1.3 seconds and 2 seconds. The power demand during this time is negative, meaning that the motor is acting as a generator and recovering energy from the deceleration of the load handling device.

The energy storage system of the load handling device must be able to provide power to enable the lowering and raising of the grabber device by the lifting drive assembly in order to retrieve or deposit a storage container. As discussed above, FIG. 29 illustrates an example of a hoist operation of the load handling device. It can be seen from FIG. 29 also that the peak demand from the electrical loads occurs for a short time only. The peak power demand for the first acceleration event occurs at around 6.5 seconds, and lasts for only a fraction of a second. The energy storage system therefore needs to provide the maximum power for only a short time. A supercapacitor is perfectly suited to provide this power boost, since it has a high power density but a low energy density. Since the demand is for a short time, a high energy storage capacity is not required. The supercapacitor can assist in meeting the power demand without adding significant extra mass or cost to the energy storage system.

Circuit Diagrams with Supercapacitor Connected in Series with Rechargeable Power Source

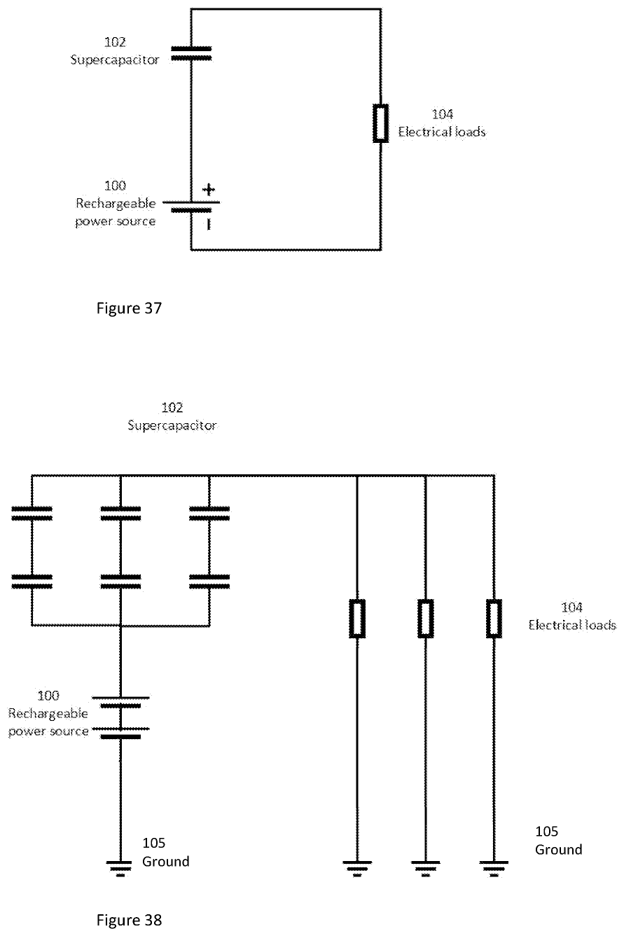

FIG. 37 illustrates a simple circuit diagram with a supercapacitor 102 connected in series with a rechargeable power source 100. The supercapacitor and rechargeable power source together provide power for the electrical loads 104. During normal operation, both the rechargeable power source 100 and the supercapacitor 102 provide power to the electrical loads 104.

FIG. 37 shows a single battery cell 100, a single supercapacitor 102, and a single electrical load 104, for ease of illustration only. The rechargeable power source 100 is not limited to a battery, and may comprise a plurality of battery cells connected in series and/or in parallel. Battery cells may be connected in series to increase the voltage (for example, a battery with nominal voltage of 48V may comprise 12 lithium-ion battery cells in series of maximum voltage 4.2V each), and/or connected in parallel to increase the energy storage capacity. The supercapacitor 102 may comprise a plurality of supercapacitors in series or in parallel; in series to increase the voltage, and in parallel to increase the energy storage capacity. The electrical loads 104 may comprise a plurality of electric motors or other components. For example, the electrical loads may comprise one or more motors as part of the lifting drive assembly, and one or more motors as part of the driving mechanism to drive the wheels of the load handling device.

FIG. 38 illustrates a circuit diagram where the rechargeable power source 100 comprises a plurality of battery cells connected in series, the supercapacitor 102 comprises a plurality of supercapacitor modules connected in series and in parallel, and the electrical loads 104 comprises a plurality of electric motors connected in parallel.

The ground 105 is common; all grounded components may be connected to the chassis of the load handling device.

### Control of Supercapacitor Charging

A controller 120 may be used to manage the charging and discharging of the supercapacitor 102. The controller may be configured to instruct the rechargeable power source 100 to charge the assembly of one or more supercapacitor modules when the voltage across the assembly of one or more supercapacitor modules is below a predetermined threshold supercapacitor recharge voltage.

The predetermined threshold supercapacitor recharge voltage may be defined to be lower than the supercapacitor's maximum rated voltage, sufficiently so that there is enough unused energy storage capacity to accept the recovered energy from a deceleration event.

A DCDC converter 122 may be used to convert the voltage between the rechargeable power source 100 and the assembly of one or more supercapacitor modules 102.

When energy is recovered from the driving mechanism and/or the lifting drive assembly of the load handling device during a deceleration event, if the voltage across the assembly of one or more supercapacitor modules is below the predetermined threshold supercapacitor recharge voltage, the controller directs the recovered energy to the assembly of one or more supercapacitor modules.

A DCDC converter may be used to convert the voltage between the load voltage and the assembly of one or more supercapacitor modules. This can be the same DCDC converter 122 that is used to convert the voltage between the rechargeable power source and the assembly of one or more supercapacitor modules.

The assembly of one or more supercapacitor modules can be selected such that it has a power rating sufficient to receive recovered power from the driving mechanism and/or the lifting drive assembly during a deceleration event, and an energy storage capacity sufficient to receive and store the recovered energy from the driving mechanism and/or the lifting drive assembly during one or more deceleration events. This ensures that all of the available recovered energy is captured and stored.

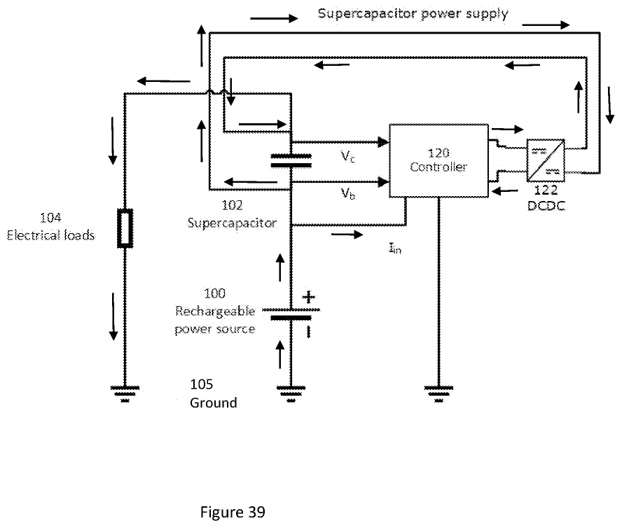

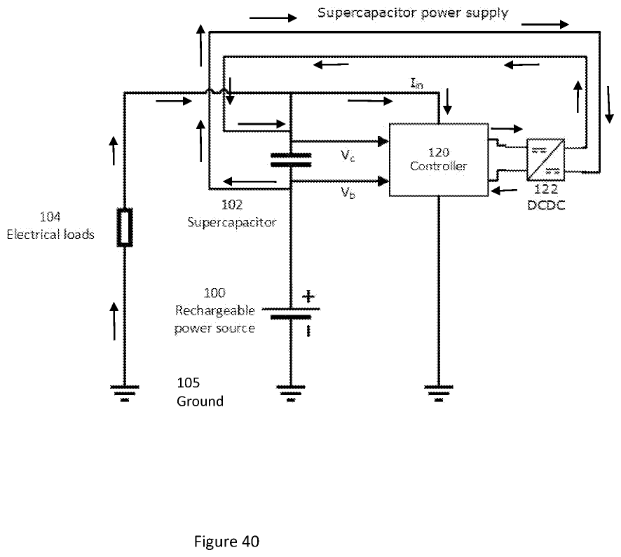

FIGS. 39 and 40 illustrate the control operation of the circuit. The controller 120 reads the voltage V_{b} across the rechargeable power source, and the combined voltage V_{c} across the rechargeable power source and the supercapacitor. The difference between these two voltages, V_{c}−V_{b}, is the voltage across the supercapacitor. If the voltage across the supercapacitor is below the predetermined threshold supercapacitor recharge voltage, the controller charges the supercapacitor. The input current Iᵢₙ to the controller can be supplied by the rechargeable power source, or alternatively can be a brake current recovered from the driving mechanism and/or the lifting drive assembly during deceleration events. The DCDC converter 122 can be used to convert the voltage of this input in order to supply the supercapacitor at the appropriate voltage.

FIG. 39 illustrates the operation of the circuit when the rechargeable power source 100 is used to charge the supercapacitor 102. The arrows on FIG. 39 illustrate the direction of current flow. The rechargeable power source 100 provides power to the electrical loads 104 and also to the supercapacitor 102 via the controller 120 and the DCDC converter 122.

FIG. 40 illustrates the operation of the circuit when recovered energy from the electrical loads 104 is used to charge the supercapacitor 102. The arrows on FIG. 40 illustrate the direction of current flow. Recovered energy from the electrical loads 104 is provided to the supercapacitor 102 via the controller 120 and the DCDC converter 122.

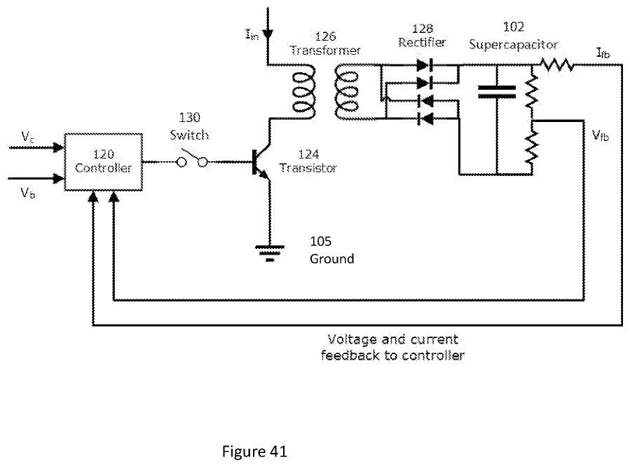

FIG. 41 illustrates one possible embodiment of the controller 120 and the DCDC converter 122 in more detail. If the voltage across the supercapacitor V_{c}−V_{b} is below the predetermined threshold supercapacitor recharge voltage, the controller 120 sends a signal, which may be a square wave, to the base of a transistor 124. When activated the transistor 124 permits the input current Iᵢₙ to flow to ground 105, through the first coil of a transformer 126. A current is induced in the second coil of the transformer 126. This current passes through a rectifier 128, and is then used to charge the supercapacitor 102. Voltage and current feedback I_{fb} and V_{fb} are measured by the controller 120 in order to monitor the output voltage and current from the DCDC converter 122.

A switch 130 can be used to protect the supercapacitor 102 from overcharging. The controller 120 can detect when the supercapacitor voltage is too high, for example when the supercapacitor voltage is over a maximum supercapacitor voltage, and can then operate the switch in order to disconnect the power supply to the supercapacitor. The switch 130 is here illustrated between the controller 120 and the base of the transistor 124, though it will be appreciated that the switch can be located anywhere in the circuit that permits the power supply to the supercapacitor 102 to be disconnected.

### Supercapacitor Protection Circuit

During normal operation the supercapacitor 102 is discharging and providing power to the electrical loads 104. When the supercapacitor is fully discharged, it will no longer be able to provide power. A supercapacitor protection circuit 132 can be used to ensure that, once fully discharged, the supercapacitor does not reverse charge. Reverse charging can cause damage to the supercapacitor.

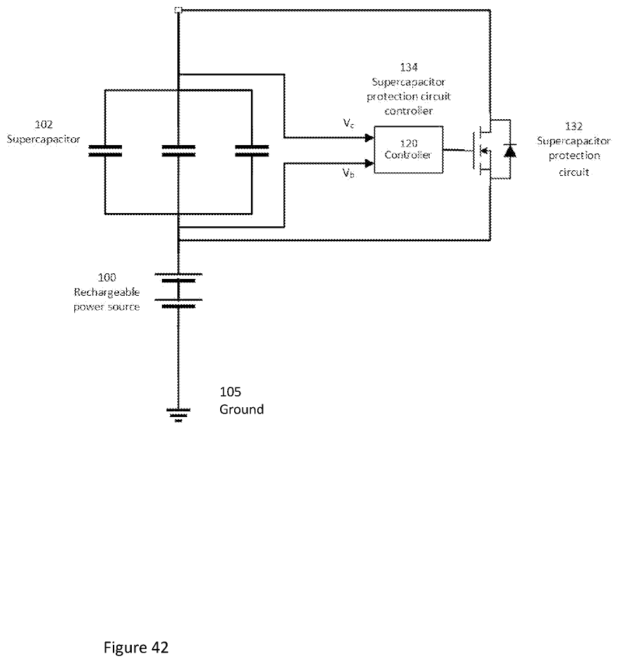

FIG. 42 is a partial circuit diagram, illustrating a supercapacitor protection circuit 132, which bypasses the supercapacitor 102. Under normal operation the supercapacitor is charged or partially charged, and discharges as current flows through it. When the supercapacitor is discharged, the supercapacitor protection circuit 132 allows current to bypass the supercapacitor rather than flowing through it.

The supercapacitor protection circuit 132 that stops the supercapacitor reverse-charging may comprise a transistor. The transistor can be controlled by a supercapacitor protection circuit controller 134. When the voltage across the supercapacitor 102 drops below zero volts, the supercapacitor protection circuit controller 134 sends a signal to the base of the transistor 132 to turn it on, and therefore allow current to flow through the transistor 132 rather than through the supercapacitor 102. The supercapacitor protection circuit controller 134 may be a separate device, or may be integrated into the same controller 120 that controls the supercapacitor charging.

The rules for control of the supercapacitor can be summarised as follows:
1. If the voltage across the supercapacitor 102 is less than predetermined threshold supercapacitor recharge voltage, the controller 120 instructs the rechargeable power source 100 to charge the supercapacitor 102 through the DCDC converter 122.
2. If the voltage across the supercapacitor 102 is less than predetermined threshold supercapacitor recharge voltage, the controller 120 directs any recovered energy from the driving mechanism and/or the lifting drive assembly to the supercapacitor 102 through the DCDC converter 122.
3. If the voltage across the supercapacitor 102 is less than zero, the supercapacitor protection circuit controller 134 activates the supercapacitor protection circuit 132 to prevent the supercapacitor 102 from reverse-charging.
4. If the supercapacitor voltage is greater than the maximum supercapacitor voltage, the controller 120 opens the switch 130 to disconnect the power supply to the supercapacitor and protect the supercapacitor 102 from overcharging.

1-26. (canceled)

27. A load handling device for lifting and moving one or more containers stacked in a storage system having a grid framework supporting a pathway arranged in a grid pattern above stacks of containers, the load handling device comprising:
i. a vehicle body housing a driving mechanism configured to be operatively arranged for moving the load handling device on a grid framework;
ii. a lifting device having a lifting drive assembly and a grabber device configured, in use, to releasably grip a container and lift the container from the stack into a container-receiving space, wherein the lifting drive assembly and/or the driving mechanism includes at least one motor forming electrical loads;
iii. a rechargeable power source; and
iv. an assembly of one or more supercapacitor modules;
wherein the electrical loads are connected across the assembly of one or more supercapacitor modules, and the rechargeable power source is connected in parallel to the assembly of one or more supercapacitor modules such that the rechargeable power source is configured and arranged to provide power to the assembly of one or more supercapacitor modules.

28. The load handling device of claim 27, comprising:
a load DCDC converter between the assembly of one or more supercapacitor modules and the electrical loads.

29. The load handling device of claim 28, in which the load DCDC converter between the assembly of one or more supercapacitor modules and the electrical loads is a boost converter.

30. The load handling device of claim 27, comprising:
a source DCDC converter between the rechargeable power source and the assembly of one or more supercapacitor modules.

31. The load handling device of claim 30, in which the source DCDC converter between the rechargeable power source and the assembly of one or more supercapacitor modules is a buck converter.

32. The load handling device of claim 27, comprising:
a controller configured to vary power supplied from the rechargeable power source to the assembly of one or more supercapacitor modules.

33. The load handling device of claim 32, in which the controller is configured to instruct the rechargeable power source to supply charge to the assembly of one or more supercapacitor modules when a voltage of the assembly of one or more supercapacitor modules is below a predetermined supercapacitor target voltage threshold.

34. The load handling device of claim 33, in which the predetermined supercapacitor target voltage threshold is lower than a maximum rated voltage of the assembly of one or more supercapacitor modules.

35. The load handling device of claim 32, in which the controller is configured to instruct the rechargeable power source to supply charge to the assembly of one or more supercapacitor modules at a predetermined threshold current for battery balancing.

36. The load handling device of claim 32, in which the controller is configured, in use, to periodically disconnect the rechargeable power source from the assembly of one or more supercapacitor modules, such that the rechargeable power source will experience periods of low current drain where no charge is supplied to the assembly of one or more supercapacitor modules.

37. The load handling device of claim 27, comprising:
an energy recovery circuit configured to divert regenerated energy from the driving mechanism and/or the lifting drive assembly to the assembly of one or more supercapacitor modules, wherein the energy recovery circuit includes a diode or transistor.

38. The load handling device of claim 27, in which the assembly of one or more supercapacitor modules is configured to have a lower internal resistance than the rechargeable power source.

39. The load handling device of claim 27, in which the electrical loads comprise:
a first portion and a second portion, where the first portion of the electrical loads includes motive power loads, and the second portion of the electrical loads includes non-motive power loads.

40. The load handling device of claim 39, in which the rechargeable power source is configured to supply charge to the non-motive power loads.

41. The load handling device of claim 27, in which the assembly of one or more supercapacitor modules is configured as a primary power supply for the load handling device, and the rechargeable power source is configured as an auxiliary power supply for providing power to the primary power supply.

42. The load handling device of claim 41, where the controller is configured to instruct the rechargeable power source to provide power directly to the electrical loads when a voltage across the assembly of one or more supercapacitor modules is below a predetermined supercapacitor voltage threshold.

43. The load handling device of claim 27, in which the assembly of one or more supercapacitor modules are distributed around an outside of a container-receiving recess within the vehicle body of the load handling device, between an outer wall and an inner wall of the load handling device.

44. The load handling device of claim 27, in which the assembly of one or more supercapacitor modules comprises at least one or more of:
capacitors, supercapacitors, ultracapacitors, lithium capacitors, electrochemical double layer capacitors, electric double layer capacitors, pseudocapacitors, and/or hybrid capacitors.

45. The load handling device of claim 27, in which the rechargeable power source comprises at least one or more of:
lithium ion batteries, lithium-ion polymer batteries, lithium-air batteries, lithium-iron batteries, lithium-iron-phosphate batteries, lead-acid batteries, nickel-cadmium batteries, nickel-metal hydride batteries, nickel-zinc batteries, sodium-ion batteries, sodium-air batteries, thin film batteries, solid state batteries, and/or smart battery carbon foam-based lead acid batteries.

46. A storage system comprising, in combination:
a grid framework supporting a pathway arranged in a grid pattern above stacks of containers; and
a plurality of load handling devices as recited in claim 27.

47. The storage system of claim 46, comprising:
one or more supercapacitor charge stations located at a grid location above an access point, in which the assembly of one or more supercapacitor modules on the load handling device is charged by one of the one or more supercapacitor charge stations during lifting or lowering operations.

48. The storage system of claim 47, in which the one or more supercapacitor charge stations are inductive supercapacitor charge stations.

49. The storage system of claim 27, in which the controller on the load handling device is configured to instruct the assembly of one or more supercapacitor modules to charge the rechargeable power source.

50. The storage system of claim 27, in which the controller is configured to instruct the one or more supercapacitor modules to supply charge to the rechargeable power source at a predetermined threshold current for battery balancing.

51. A fulfilment centre, comprising in combination:
the storage system of claim 50; and
a plurality of load handling devices.

52. The fulfilment centre of claim 51, in which a temperature inside the fulfilment centre is any one or more of:
an ambient temperature at or above 4° C.;
a refrigerated temperature between substantially 0° C. to substantially 4° C.; and/or
a frozen temperature between substantially −25° C. to substantially 0° C.
